(19) United States
(12) Patent Application Publication
(10) Pub. No.: US 2025/0047492 A1
(43) Pub. Date: Feb. 6, 2025

(54) PRIVACY-PRESERVING FACIAL SCREENING

(71) Applicant: UT-Battelle, LLC, Oak Ridge, TN (US)

(72) Inventors: Suhas Sreehari, Knoxville, TN (US); Hector Santos-Villalobos, Knoxville, TN (US)

(21) Appl. No.: 18/791,869

(22) Filed: Aug. 1, 2024

Related U.S. Application Data
(60) Provisional application No. 63/530,101, filed on Aug. 1, 2023.

(51) Int. Cl. H04L 9/32; G06F 9/451; G06V 10/774; G06V 10/82; G06V 10/94; G06V 40/16

(52) U.S. Cl. CPC H04L 9/3231; G06F 9/451; G06V 10/774; G06V 10/82; G06V 10/95; G06V 40/168; G06V 40/172

(57) ABSTRACT

Privacy-preserving security screening using facial images is disclosed. The screening may comprise encoding a facial image into a latent vector using a first pre-trained machine learning model, shuffling the latent vector using an invertible transformation in a latent space to generate a shuffled latent vector and converting the shuffled latent vector into a landscape image using a second pre-trained machine learning model. The landscape image may be used to security screening and compared with reference landscape images.

### CROSS-REFERENCE TO RELATED APPLICATIONS

This application claims the benefit of U.S. Provisional Application No. 63/530,101, filed on Aug. 1, 2023, which is incorporated by reference herein in its entirety.

### STATEMENT REGARDING FEDERALLY SPONSORED RESEARCH OR DEVELOPMENT

This invention was made with Government support under DE-AC05-00OR22725 awarded by US Department of Energy. The Government has certain rights to this invention.

### FIELD OF THE DISCLOSURE

The disclosure relates generally to computers, computer applications using machine learning for screening people using captured facial images. More specifically, the disclosure relates to privacy-preserving screening.

### BACKGROUND

Screening of people for security is commonplace. For example, airports, buildings, stadiums, typically have a camera system for capturing an image/video of people entering. A security officer (e.g., security guard) may view of the captured image to determine whether the person matches a list of suspects, a black list, no fly list (collectively “reference list”). This reference list may have images of the persons who are a security risk.

However, facial recognition is a double-edged sword: on the one hand, it can help make biometric security more reliable with increased precision and recall. On the other hand, it can create personally identifiable data that could lead to tracking of people with undesirable consequences and loss of privacy. In addition, biometric security based on facial recognition is often plagued with human biases based on perceived religious affiliation, age, sex, ethnicity, and skin tone/race such as during the above manual inspection. Facial recognition must shift from conventional methods of matching faces to database templates, to a mechanism that is visually devoid of personally identifiable features yet encoded to carry enough information for such a template matching.

### SUMMARY

Accordingly, disclosed is a non-transitory computer-readable medium storing computer-readable instructions for use in security screening. The computer-readable instructions, when executed by a processor cause the processor to perform operations comprising receiving a facial image of a person, encoding the facial image into a latent vector using a first pre-trained machine learning model, shuffling the latent vector using an invertible transformation in a latent space to generate a shuffled latent vector, and converting the shuffled latent vector into a landscape image using a second pre-trained machine learning model. The landscape image may be subsequently used for security screening.

In an aspect of the disclosure, the machine learning models may be different machine learning techniques. For example, the first pre-trained machine learning model may be an autoencoder deep learning network and the second pre-trained machine learning model may be a generative adversarial network (GAN). In some aspects, the GAN may be StyleGAN 2.

In an aspect of the disclosure, the shuffling comprises determining a block index number of the latent vector based on a defined indexed latent space, determining a new block index number based on a bijective sequence of numbers, and moving the latent vector within the latent space based on the new block index number. The latent space may be divided into blocks. Each block has a block index number. The block index number of the latent vector defines a term number within the bijective sequence. The moving may be based on the following equation:

$$\tilde{v} = {z}_{{R}^{′} ( {j}_{v} )} + v - {z}_{{j}_{v}} ,$$

where blocks are denoted by {Bⱼ}, where zⱼ denotes a vector that points to a center of a j-th block, jᵥ denotes the determined block index number of the latent vector, and R′(jᵥ) is the new block index number determined from the bijective sequence of numbers and v is the latent vector.

In other aspects of the disclosure, the shuffling comprises determining an Euclidean distance between the latent vector and a predefined center of the latent space and moving the latent vector based on the determined Euclidean distance, a rotation matrix and a scaling function.

In an aspect of the disclosure, the latent vector may be encrypted prior to transmission. In this aspect, the computer-readable instructions further cause the processor to encrypt the latent vector and transmit the encrypted latent vector to an external screening station.

In an aspect of the disclosure, the computer-readable instructions further cause the processor to train the models and define shuffling parameters for the invertible transformation based on the training.

Also disclosed is a screening system comprising a camera system, an initial screening sub-system and a confirmation sub-system. The camera system, the initial screening sub-system and the confirmation sub-system are communicatively coupled with each other.

The camera system comprises a camera-side communication interface, a camera-side memory configured to store a first pre-trained machine learning model, a second pre-trained machine learning and at least one shuffling method and associated parameter(s), a camera configured to capture a facial image of a person and a camera-side processor. The camera-side processor is configured to encode the facial image into a latent vector using the first pre-trained machine learning model, shuffle the latent vector using one of the shuffling methods and its associated parameter(s) stored in memory to invertibly transform the latent vector in a latent space, to generate a shuffled latent vector, convert the shuffled latent vector into a landscape image using the second pre-trained machine learning model and transmit the landscape image to the initial screening sub-system via the camera-side communication interface. The initial screening sub-system comprises a screening-side communication interface, a screening-side memory configured to store the received landscape image and a plurality of reference landscape images, a screening-display, a screening-side user interface and a screening-side processor. The screening-side processor is configured to cause the received landscape image and at least a subset of the plurality of reference landscape images to be displayed on the screening-display for comparison, receive a comparison result via the screening-side user interface and in response to the comparison result indicating a match, transmit the received landscape image to the confirmation sub-system.

In an aspect of the disclosure, the camera-side processor may be further configured to encrypt the latent vector and transmit the encrypted latent vector to the confirmation sub-system.

In an aspect of the disclosure, the confirmation sub-system may comprise a conformation-side communication interface, a confirmation-side memory configured to store at least one of a plurality of reference facial images or a plurality of reference landscape images, the received landscape image, and the first pre-trained machine learning model, a confirmation-side display, a confirmation-side user interface and a confirmation-side processor. The confirmation-side processor may be configured to receive the encrypted latent vector and decrypt the encrypted latent vector and store the decrypted latent vector in the confirmation-side memory, convert the decrypted latent vector into a recreated facial image using the first pre-trained machine learning model to recreate a facial image as the recreated facial image, display the recreated facial image and display at least a subset of the plurality of reference facial images, receive a result of comparison; and cause an alert to be generated at least based on the comparison.

In an aspect of the disclosure, the camera-side processor may download the first pre-trained machine learning model, the second pre-trained machine learning model and the at least one shuffling method and associated parameter(s) from a server.

In an aspect of the disclosure, the server may train the first pre-trained machine learning model based on training facial images downloaded from an image repository and train the second pre-trained machine learning model.

In an aspect of the disclosure, at least a subset of the associated parameter(s) for each shuffling method may be based on respective latent vectors determined from the training facial images used to train the first pre-trained machine learning model.

In an aspect of the disclosure, the initial screening sub-system may download the plurality of reference landscape images from an external database and the confirmation sub-system may download the at least one of a plurality of reference facial images or a plurality of reference landscape images from the external database. These images may be updated, such as periodically.

In an aspect of the disclosure, the models may be retrained in response to a training condition being satisfied.

Also disclosed is an apparatus comprising a communication interface, a memory and a processor. The memory is configured to store a first pre-trained machine learning model, a second pre-trained machine learning model, at least one shuffling method and associated parameter(s) and one or more reference landscape images. The processor is configured to receive a facial image via the communication interface, encode the facial image into a latent vector using the first pre-trained machine learning model, shuffle the latent vector using one of the shuffling methods and its associated parameter(s) stored in memory to invertibly transform the latent vector in the latent space, to generate a shuffled latent vector, convert the shuffled latent vector into a landscape image using the second pre-trained machine learning model, display the landscape image along with the one or more reference landscape images, receive a comparison result via a user interface and cause a notification to be generate based on the comparison.

Also disclosed is a server comprising a communication interface, a memory and a processor. The processor is configured to train a first machine learning model based on a plurality of facial images to encode facial images into latent vectors, determine parameters associated with at least one shuffling method for transforming latent vectors which are encode using the first machine learning model from facial images, respectively, for screening, train a second machine learning model to convert latent vectors into landscape images, respectively, and transmit the trained first machine learning model, the trained second machine learning model and the parameters associated with at least one shuffling method to a screening apparatus.

Also disclosed is a system for authenticating a user. The system comprises a memory configured to store information for a plurality of registered users, The information for each of the plurality of registered users comprising a user identifier, a user password and a unique landscape image. Each unique landscape image is generated from a facial image of a user, respectively, by using a first machine learning model and a second machine learning model. The first machine learning model encodes the facial image into a latent vector. The second machine learning model converts a shuffled latent vector into the unique landscape image. The latent vector is shuffled using an invertible transformation in a latent space to generate the shuffled latent vector.

The system also comprises a processor configured to receive a request for access via a communication interface from first user equipment of a user, the request including at least a user identifier of the user requesting access and a user password of the user requesting access; match the user identifier and the user password in the request with a user identifier and user password in the memory, in response to a match, transmit, to second user equipment of the user, a plurality of landscape images including (i) the unique landscape image of the registered user whom matched the user identifier and the user password and (ii) other landscape images different from the unique landscape image, receive, from the second user equipment, a selection of one of the plurality of landscape images; and in response to the selection being the unique landscape image, grant access.

In an aspect of the disclosure, the first user equipment and the second user equipment are different.

In an aspect of the disclosure, the other landscape images of the plurality of landscape images are randomly generated by the processor in response to the matching. In an aspect of the disclosure, the number of the plurality of landscape images is 4. In other aspects, the number is selectable.

In an aspect of the disclosure, in response to the selection being one of the other landscape images, the processor is configured to transmit, to the second user equipment, another plurality of landscape images including (i) the unique landscape image and other landscape images different from the other landscape images in the previously transmitted plurality of landscape images and the receiving of the selection is repeated. In this aspect, a notification may be transmitted to the first user equipment.

Also disclosed is a system for authenticating a user. The system comprises a memory configured to store information for a plurality of registered users. The information for each of the plurality of registered users comprises a user identifier and a unique landscape image. Each unique landscape image is generated from a facial image of a user by using a first machine learning model and a second machine learning model. The first machine learning model encodes a facial image into a latent vector. The second machine learning model converts a shuffled latent vector into a unique landscape image. The latent vector is shuffled using an invertible transformation in a latent space to generate the shuffled latent vector. The system also comprises a processor configured to receive a request for access via a communication interface from user equipment of a user, the request including at least a user identifier and a unique landscape image of the user, match the user identifier in the request with a user identifier in the memory to obtain the information of the registered user, upon obtaining the information of the registered user, match the unique landscape image of the user in the request with the unique landscape image of the registered user stored in the memory; and in response to a matching of the unique landscape images, grant access.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates a system in accordance with aspects of the disclosure;

FIG. 2 illustrates a method for configuring a screening system in accordance with aspects of the disclosure;

FIG. 3 illustrates an example conversion from a facial image into a latent vector in a latent space using a first model in accordance with aspects of the disclosure;

FIG. 4A illustrates an example of datapoints of a training image for two features in the latent vector, e.g., F1, F2, in accordance with aspects of the disclosure without synthesized datapoints;

FIG. 4B illustrates an example of datapoints for the training image in FIG. 4A with synthesized datapoints;

FIG. 5 illustrates an example of descriptive features for facial images and its correspondence to keywords in landscape images which may be used to identify a correlation between a facial image and its corresponding landscape image;

FIG. 6 illustrates a method of determining a shuffling of the latent vector in accordance with aspects of the disclosure;

FIG. 7 illustrates an example of clustering to define a block in accordance with aspects of the disclosure;

FIG. 8 illustrates an example of blocks in the latent space and indexing in accordance with the method illustrated in FIG. 6;

FIG. 9 illustrates another method of determining a shuffling of a latent vector in accordance with aspects of the disclosure;

FIG. 10 illustrates an example of the shuffling in accordance with the method illustrated in FIG. 9;

FIGS. 11A-11C illustrate a comparison of the results from shuffling methods illustrated in FIGS. 6 and 9 and no shuffling;

FIG. 12 illustrates an example conversion from a shuffled latent vector in a latent space to a landscape image using a second model in accordance with aspects of the disclosure;

FIG. 13A illustrates a first portion of a screening method in accordance with aspects of the disclosure;

FIG. 13B illustrates an example of conversions of facial images into landscape images in accordance with aspects of the disclosure;

FIG. 14 illustrate examples of the facial images of the same person in three difference poses and corresponding similar landscape images;

FIG. 15 illustrate examples of the facial images of different persons and their corresponding different landscape images;

FIG. 16A illustrates a second portion of the screening method in accordance with aspects of the disclosure;

FIG. 16B illustrates an example of the mapping of facial images to landscape images for screening purposes in accordance with aspects of the disclosure;

FIG. 17A illustrates a third portion of the screening method in accordance with aspects of the disclosure;

FIG. 17B illustrates a comparison between a screening method in accordance with aspects of the disclosure and a known screening method;

FIG. 18 illustrates another system in accordance with aspects of the disclosure;

FIG. 19 illustrates a screening device in accordance with aspects of the disclosure;

FIG. 20 illustrates the memory of the screening device of FIG. 19 in accordance with aspects of the disclosure;

FIG. 21 illustrates a user authentication method in accordance with aspects of the disclosure; and

FIG. 22 illustrates another user authentication method in accordance with aspects of the disclosure.

### DETAILED DESCRIPTION

Aspects of the disclosure, provide systems, methods and programs including machine learning techniques which can convert a facial image into a corresponding landscape image which may be used for security screening.

A facial image may be first reduced to a latent vector in a latent space using a first machine learning model (First Model). In some aspects, this latent vector may be shuffled (transformed) to further enhance privacy into a shuffled latent vector. A second machine learning model (Second Model) may be used to convert the shuffled latent vector into a landscape image. The landscape image may be displayed to a security officer (an example of an operator) for security screening. For example, references landscape images, such as included in a blacklist, a no-fly list, or access control list, may also be displayed and the generated landscape image may be matched to one of the reference landscape images. If there is a match, the landscape image (which was generated) may be flagged for further processing.

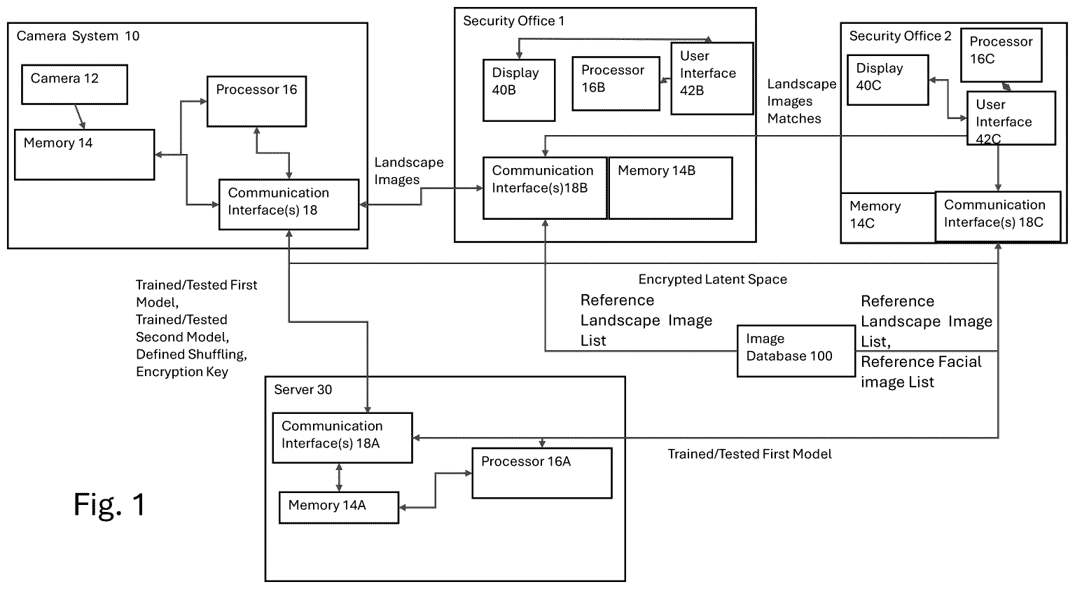

FIG. 1 illustrates a system in accordance with aspects of the disclosure. The system comprises a camera system 10, a security office 1, security office 2, and a server 30. In some aspects, the system may include an image database 100. The server 30 trains and tests the first model and the second model. The server 30 also may be used to define a shuffling 465 of a latent vector R^{K} 260. In some aspects, the server 30 may also define an encryption key to encrypt the latent vector R^{K} 260 for transmission. The trained/test first model and second model may be used by different security screen systems (e.g., camera system 10, security office 1 and security office 2).

The server 30 may comprise a processor 16A, a memory 14A and a communication interface(s) 18A. In some aspects of the disclosure, the processor 16A may be one or more graphics processing unit GPUs. In other aspects, the processor 16A may be one or more central processing unit(s) CPUs, microcontroller or microprocessor or any other processing hardware such as a field programmable gate array (FPGA) or an application specific integrated circuit (ASIC). In an aspect of the disclosure, the processor 16A may be configured to execute one or more programs stored in a memory 14A to execute the functionality described herein. The memory 14A may be, for example, RAM, persistent storage or removable storage. The memory 14A may be any piece of hardware that is capable of storing information, such as, for example without limitation, data, programs, instructions, program code, and/or other suitable information, either on a temporary basis and/or a permanent basis.

One CPU or GPU may execute the functionality described herein or multiple CPUs or GPUs may collectively execute the functionality described herein. For example, the CPUs or GPUs may execute some of the functionality in parallel to speed up the training and testing process, such as one CPU or GPU training and testing the first model and another training and testing the second model.

The communication interface(s) 18A may be a wired or wireless communication interface. In some aspects of the disclosure, the communication interface(s) 18A may be connectable to the internet. In other aspects of the disclosure, the communication interface 18A may be configured for secure communication.

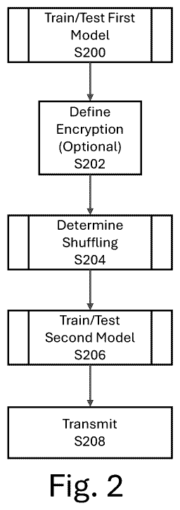

FIG. 2 illustrates a method, executed by the server 30, in accordance with aspects of the disclosure. At S200, the server 30 trains/tests the first model. In some aspects, the server 30 downloads a plurality of facial images from an image repository. The image repository may be a public database of facial images. The plurality of facial images may include representative images of the population including different races, ethnicity, age, religion, etc. The facial images may include multiple facial images of the same person such as different poses, and facial expressions. The facial expressions may include happy (open and closed mouth), angry, fearful, etc.

In some aspects, the image repository may also include facial images from other repositories include police camera images, airport security images and other government owned cameras.

In an aspect of the disclosure, each facial image 252, in the training dataset, is the same resolution (and aspect ratio). The resolution may be a customizable parameter. The resolution of the facial image in the training/testing dataset may be selected to be similar to the resolution in an expected facial image for security screening. If the resolution is different, the facial image 252 for security screening may need to be down sampled prior to conversion. The resolution for the facial images in the training dataset may be set in a lower range of the expected resolution of the facial images for security screening. Different cameras 12 of a camera system 10 may have different resolutions. Setting to a lower range may prevent a need to up sample the image. Up sampling may distort the facial image and reduce the quality. An image repository may comprise facial images of different resolutions, therefore, the processor 16A may only extract/download facial images 252 having the selected resolution. For example, modern digital cameras have over 20 million pixels (20 Mega pixels).

Where the facial images 252 have different aspect ratios, the processor 16A may crop a facial image down to a set aspect ratio. For example, the set aspect ratio may be 4:3 or 1:1.

The processor 16A, for each facial image 252 in the training dataset, creates a vector representation R^{N} 255 of the facial image. N is the number of image pixels 250 in the facial image 252. Each entry in the vector represents a color value for the image pixel 250 in the facial image. A preset color space may be used. For example, the color space may be a RGB color space. The entry may have three channels, one channel for Red (R), another channel for Green (G), and another channel for Blue (B). In an aspect of the disclosure, each channel may be 8-bits for a total of 24-bits per entry. Thus, each channel may have 256 levels. The color space is not limited to RGB color space and other color spaces such as Lab may be used where “L” represents a brightness, “a” represents a hue and “b” represents a saturation. In other aspects, the color space may be Cyan Magenta Yellow Black (CMYK).

The processor 16A executes a raster scan of each facial image 252 (in the training dataset) to create the vector representation R^{N} 255 of the facial image 252. The vector representation R^{N} 255 of each facial image in the training dataset is the input to the first model.

The first model may be a deep learning network. In some aspects, the first model may be an autoencoder (AE), which is able to encode the facial images 252 into latent vectors R^{K} 260. AE comprises an encoder 455 and a decoder (not shown). The decoder is used during the training phase but is not used after training (e.g., deployment). The encoder 455 converts the vector representation R^{N} 255 into the latent vectors R^{K} 260 and the decoder recreates the vector representation R^{N} 255 from the latent vectors R^{K} 260. A latent vector R^{K} 260 has a much smaller dimensions than the vector representation R^{N} 255, e.g., K<<N.

In some aspects, the AE may use a cross-entropy loss function

$$L = {\sum }_{k} {x}_{k} log \{ {z}_{k} \} + ( 1 - {x}_{k} ) log \{ 1 - {z}_{k} \} , \qquad ( 1 )$$

where xₖ is the k-th original image and zₖ is its reconstruction at the end of the decoder.

However, the loss function is not limited to the above equation. For example, a mean squared error (MSE) loss and a mean absolute error (MAE) function may be used.

The number of convolution and max pooling layers and nodes in a layer may be customizable parameters based on processing power, desired training time and size of the dataset.

The decoder has a plurality of convolution layers and up sampling to reconstruct the original vector representation R^{N} 255.

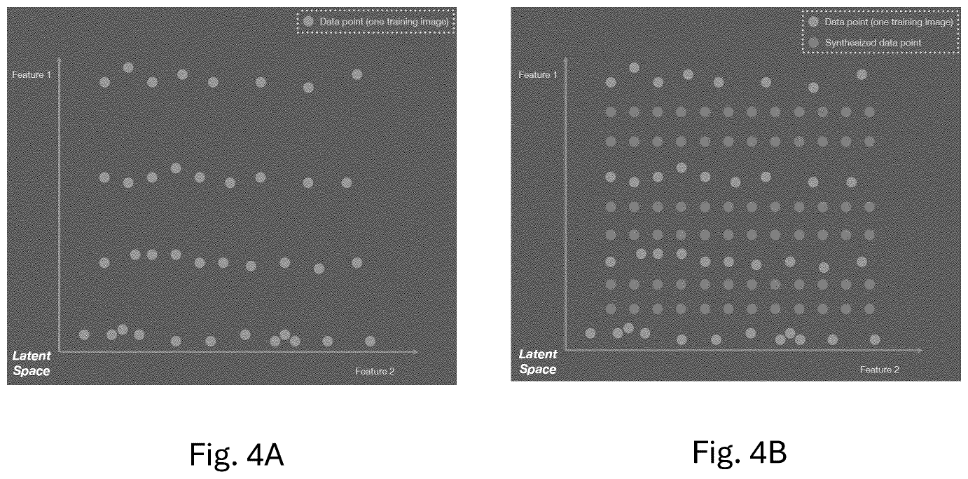

In some aspects of the disclosure, the maximum size of the latent vector (e.g., K) may be customized as well. Each entry in the latent vector R^{K} in the latent space represents one visual feature of the facial image 252. Depending on the dataset using in training, not all features are represented equally in the training data, which can cause some latent vector entries to be sparser than others. Additionally, the dataset may not include all facial features of the population (although the goal is to select a diverse set). For such non-uniform latent space resolution, sparser elements have lower latent resolution than denser ones, as shown in FIG. 4A.

In an aspect of the disclosure, the processor 16A generates synthesized data points in the latent space to create a more uniform represent across different image features. The processor 16A examines the generated latent vectors from the encoder 455 and determines a target resolution for each feature, e.g. entry. In some aspects, the target resolution may be the highest resolution of any feature. Once, the target resolution is identified, for each feature less than the target, the processor 16A super-resolves each feature to achieve this target resolution.

In other aspects, an operator may examine the latent space to determine gaps or the different resolutions during training. In order to even out the resolution, facial images may be synthesized having the gap features using an image generator such as a generative adversarial network. The facial images generated by the GAN may be used in a subsequent training to create additional latent vectors. In other aspects, an operator may select specific images from other image repositories based on the analysis of the latent vectors (and gaps in the latent space) to fill in the gaps to increase the resolution in the lower resolution axes. The selected specific images may be used for training.

Thus, the training may be multiple iterations.

FIG. 4B illustrates an example, of the synthesized data points (and the actual data points) for a facial image used in training.

The determined latent vectors R^{K} 260 for the facial images in the training dataset may be stored in memory 14A.

Certain downloaded facial images may be held back for testing of the first model. The first model may be tested by a human operator comparing the initial facial image 252 and the facial image produced by the decoder of the AE from the latent vectors R^{K} 260.

The first model is not limited to AE and other machine learning techniques for reducing the dimensionality of the original vector representation R^{N} 255 may be used. For example, PCA or NMF may be used. Additionally, a variational autoencoder (VAE) may be used.

At S202, the processor 16A may define an encryption method and key used for transmission of the latent vectors R^{K} 260 during a screening process. Encryption may be used to ensure that the decoding of a human face from the latent vector R^{K} 260 requires authentication. This is to protect the privacy of people during the screening process. This is because there is a one-to-one correspondence between a latent vector R^{K} 260 and the original vector representation R^{N} 255. In some aspects, a landscape image 475, which is generated based on the second model, may also be encrypted. Different encryption methods and keys may be used for the latent vector R^{K} 260 and the landscape image 475. The strength of the encryption may be a customizable parameter based on the application. For example, airport screening may require stronger encryption than commercial building screenings.

In some aspects, the processor 16A may randomly generate an encryption key. The encryption key may be stored in the memory 14A. In some aspects, the encryption key may be generated when the first model/second model and shuffling method/parameters is downloaded by the camera system 10. For example, when the camera system 10 downloads the model/second model and shuffling method/parameters, the camera system 10 in conjunction with the server 30 may generate the encryption key.

At S204, the processor 16A determines a shuffling 465 and/or parameter(s) that may be used during the screening process for transforming the latent vector R^{K} 260 generated from a facial image. The purpose of the shuffling 465 in the latent space is to produce a “transformed” latent vector that is unique to the facial image and at the same time “decorrelated” (from the original latent vector R^{K} 260 and facial image). The “decorrelation” is to protect the landscape images 475 from being reverse-engineered to estimate the bias-inducing bias features, e.g., race, sex, age, religion, etc. The shuffling 465 essentially masks any visual correlations between the features of a landscape image 475 (which is generated from the shuffled latent vector R′^{K} 260′) and the facial features. If the natural landscape images exhibit a visual correlation between its features and the corresponding facial features, it would be possible to construct an algorithm to reverse engineer faces from the landscape images 475. At the minimum, it would be easy enough to estimate sensitive and bias-inducing characteristics of the encoded faces. An example would be to associate types of trees in a landscape image to the skin color of the corresponding face. This would defeat the purpose of mapping faces into landscape images. In addition, it might even give a false sense of protection against bias.

In some aspects, the shuffling may be a non-linear transformation. Once again, the non-linear shuffling/transformation ensures that the visual correlations between features in the landscape images 475 and the corresponding facial features are reduced.

In some aspects of the disclosure, the shuffling method may be selectable from two or more transformation techniques. For example, one transformation technique may be based on a Recaman sequence. A Recaman sequence is defined by a recursive relationship between members of the sequence. The first term in the sequence is defined by the initial condition, e.g., 1. The next term in the sequence is defined by the value of the first term and +/−the index number. The terms in the sequence may be defined by the following equations:

$$For all k < j , if R ( k ) = R ( j - 1 ) - j , then R ( j ) = R ( j - 1 ) - j ; \qquad ( 2 )$$

$$Otherwise , R ( j ) = R ( j - 1 ) + j ,$$

However, there may be repeated terms in the sequence, e.g., it is not bijective. Therefore, the standard Recaman sequence may be modified such that the sequence is bijective, e.g., taking a unique subset of the Recaman sequence without duplication. In an aspect of the disclosure, the Recaman sequence may be modified as follows:

$$For all k < j , if {R}^{′} ( k ) = {R}^{′} ( j - 1 ) - j , then {R}^{′} ( j ) = {R}^{′} ( j - 1 ) - j ; \qquad ( 3 )$$

$$Otherwise , {R}^{′} ( j ) = R ( j - 1 ) + mj ,$$

where j is the index, m is a small positive integer such that R′(k)≠R′(j−1)+mj∀k<j, and R′(1)=1.

In the above set of equations, “1” is the initial condition. However, in other aspects of the disclosure, the initial condition is a customizable parameter of the shuffling 465. In other aspects of the disclosure, the processor 16A may randomly set the initial condition.

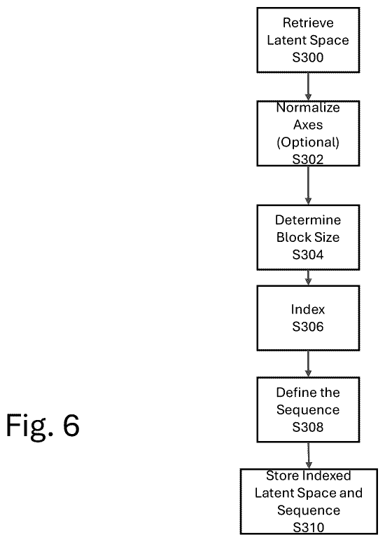

While shuffling 465 is not required for training, the latent vector R^{K} 260 determined for each facial image 252 in the training dataset may be used to define the shuffling, e.g., transformation. FIG. 6 illustrates a method for defining the shuffling 465 based on a “modified” Recaman sequence in accordance with aspects of the disclosure (“MR transformation”).

At S300, the processor 16A may retrieve the latent vector R^{K} 260 determined for each facial image 252 in the training dataset from memory 14A. Each latent vector R^{K} 260 defines a point in a multi-dimensional latent space. However, the different dimensions may have a different axes length. Therefore, in order to simplify processing, the axes for each of the multiple dimensions may be normalized at S302. Thus, each normalized latent vector R^{K} may have different values for the features than determined above.

To apply the MR transformation, the latent space is discretized into “blocks”, so that the set of countable indices of an MR sequence can be used to sweep through the latent space. The “blocks” are defined not to overlapping in the latent scape, yet to span the entire latent space. At S304, the processor 16A determines the block size and shape. In some aspects of the disclosure, the shape may be cuboid-basis (higher-dimension). However, the shape is not limited to cuboid-based, but may be ellipsoid-based such as a hypersphere or triangular-based such as simplicial complex to completely cover the entire latent space without gaps.

In an aspect of the disclosure, each block is the same size. The size of the block may be determined by clustering techniques. For example, a block should include different latent vector R^{K} 260 generated from facial images 252 of the same person, such as in different poses or facial expressions, but exclude different latent vector R^{K} 260 generated from facial images 252 of different people.

In some aspects of the disclosure, the clustering may be manual. For example, an operator may look at latent vectors R^{K} 260 determined from facial images 252 of the same people. The center of the latent space with respect to these latent vectors may be determined and a Euclidean distance from the center to each latent vector determined for the same person may be calculated. Then an average of this distance may be determined. This process may be repeated for each person within the training dataset and different poses and facial expressions. Once all of the averages of the Euclidean distances are determined per person, and average of the averages may be taken. The average (of the averages) may be set as the block size. In other aspects, instead of average a median may be used.

In other aspects, the processor 16A may use a machine learning clustering technique. For example, the clustering technique may be centroid-based or density-based. In some aspect, K-means clustering may be used. In other aspects, the clustering technique may be distribution-based, such as a gaussian distribution.

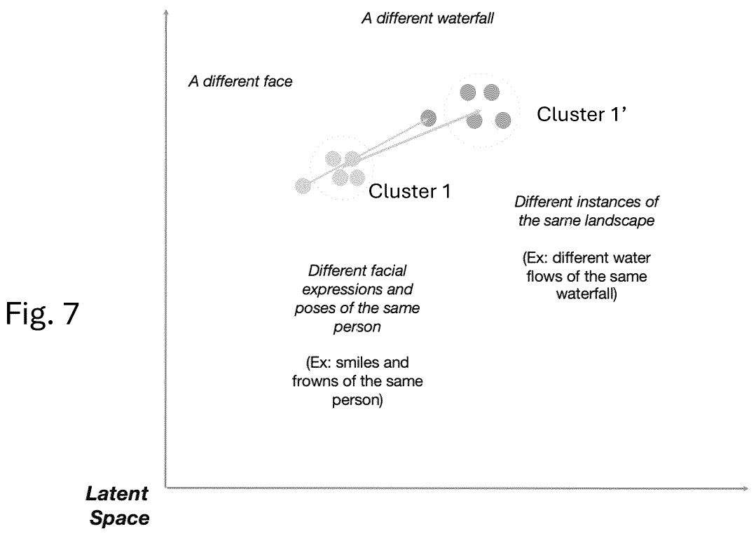

In other aspects, the clustering technique may include a human-in-the-loop aspect where an operator of the server 30 may assist in the clustering. FIG. 7 illustrates a cluster 1 having four elements (latent vector R^{K} 260) (represented by blue dots). The four elements are different facial expression and poses of the same person. For representation in the figure, the latent space is shown in 2-D, however, the latent space is K dimensions. For comparison, the green dot, is a latent vector R^{K} 260 generated from a facial image 252 of a different person (outside the cluster 1). Therefore, the block size may be set based on the volume within the dotted circle.

The shuffling 465 described herein, will cause the cluster 1 to be moved in the latent space to cluster 1′. The green dot (outside cluster 1) will be moved in the latent space as shown. However, the green dot will remain outside cluster 1′. The moves retain continuity of the transform. Meaning that the features within the cluster will be mapped to different instances of the same landscape, e.g., different water flows from the same waterfall. Whereas, for a shuffled latent vector R^{K} 260′ outside of the cluster 1′, it will be mapped to a different landscape, such as a different waterfall. Given that the green dot is close to cluster 1′ the mapping may still be to a water, however, if the distance is greater than mapping may be to another view entirely, e.g., beach.

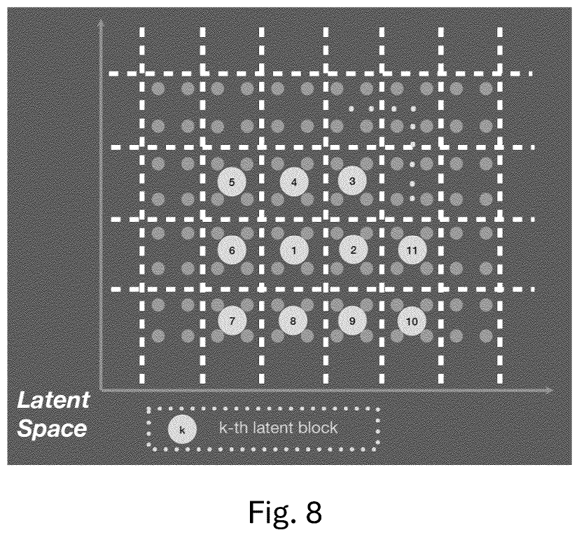

At S306, the latent space is indexed based on the determined block size (and shape). For example, in an aspect of the disclosure, the processor 16A determines the block at the center of the latent space and assigns this block “1”. The processor 16A may move outward from this block in a spiral pattern and assigned, incrementally index numbers to the other blocks. For example, the spiral may be counter-clockwise. FIG. 8 illustrates an example of the assignment of the index number to blocks in accordance with aspects of the disclosure. In FIG. 8, once again, the latent space is shown in 2-D for illustrative purposes, but the latent space has K dimensions. Additionally, the axes are shown represent 2 different features. Additionally, the blocks are shown as squares, however, as noted above, the shape is not limited to cuboid. FIG. 8 also shows each block to have 4 latent vectors, however, the number of latent vectors within each block is not limited to 4. The dashed lines represent the blocks.

As can be seen, one of the blocks is assigned “1”. To the right of this block, the block is assigned “2”. The eight adjacent blocks to block “1” is assigned an index number sequentially, e.g., 2, 3, 4, . . . (counter-clockwise spiral). However, the spiral may be clockwise. After block 9, the spiral extends to the next level with block 10, 11, . . . . The dots in the three blocks after block 11 indicate the assignment pattern for the subsequent blocks.

Not all of the latent space is shown. For example, there are blocks below blocks 7, 8, 9, 10, to the right of blocks, 10, 11, above, blocks 3, 4, 5, and to the left of blocks 5, 6, 7, which are not shown. These blocks are represented by the open dashed lines at the outer peripheral of the view.

At S308, the sequence is defined. As described above, the sequence is generated using equations 3 and an initial condition. At S308, the initial condition may be set, and the sequence calculated. At S310, the determined sequence and the indexed space may be stored in memory 14A for subsequent used by the camera system 10.

The shuffling of a latent vector (here denoted at v) is determined by

$$\tilde{v} = {z}_{{R}^{′} ( {j}_{v} )} + v - {z}_{{j}_{v}} , \qquad ( 4 )$$

where the blocks are denoted by {Bⱼ}where zⱼ denotes the vector that points to the center of the j-th block, jᵥ denotes the index of the block that the latent vector v belongs to, and R′(jᵥ) is the value of the jᵥ-th index of the modified Recaman sequence.

For example, using the indexing in FIG. 8, the third element in the sequence may be 6. Therefore, block 3 may be moved to where block 6 is located in FIG. 8.

In other aspects of the disclosure, the shuffling 465 may be a radial transformation. Once again, the parameters for the shuffling 465 may be based on the latent vector R^{K} 260 determined for each facial image 252 in the training dataset. At S300, the processor 16A may retrieve the latent vector R^{K} 260 from memory 14A. Similar to above, the axes in the latent space may be normalized for processing and each normalized latent vector R^{K} may have different values for the features than determined above.

At S900, the processor 16A may determine the center of the latent space. The center of the latent space defines the pivot. The center of the latent space is determined by taking the average of each feature in the latent space.

At S902, the processor 16A may determine the rotation matrix. The rotation matrix defines an angle of rotation of the latent vector R^{K} 260 in the latent space with respect to the determined center. The rotation matrix defining either a clockwise rotation by θ or a counter-clockwise rotation. In some aspects, the rotation matrix may define a rotation with respect to pairs of the axes. For example, the rotation matrix may be:

$$R = [ \begin{matrix}cos θ & - sin θ \\ sin θ & cos θ\end{matrix} ] \qquad ( 5 )$$

R may be repeatedly multiplied by different pairs of the latent vector R 260. For example, the first term and the second term in the latent vector R^{K} 260 may be rotated by R and the third term and the fourth term may be rotated by R. In other aspects, the first term and the second term in the latent vector R^{K} 260 may be rotated by R and afterwards, the second term and third term may be rotated by R.

In this example, the rotation is a counter-clockwise rotation in radians.

In some aspects of the disclosure, an operator may enter the rotation matrix into the server 30 as a customizable parameter.

At S904, the processor 16A may determine a scaling function. The scaling function may be a positive, continuous function. The scaling function stretches or shrinks a latent vector R^{K} 260 (with respect to the center). For example, the scaling function may be 2 x, where x is the latent vector with respect to the center. Thus, the latent vector is stretched. In some aspects, the function may also change the “intercept”. For example, the function may be ax+b, where b is a non-zero number. In some aspects of the disclosure, an operator may enter the function into the server 30 as a customizable parameter.

In an aspect of the disclosure, the same rotation and stretching/shrinking may be applied to all features within the latent space. However, in other aspects, the features may be groups and features within a group in the latent space may have one rotation and stretching/shrinking whereas features within another group in the latent space may have another rotation and stretching/shrinking.

At S906, the determined center of the latent space, the rotation matrix and the scaling function are stored in memory 14A.

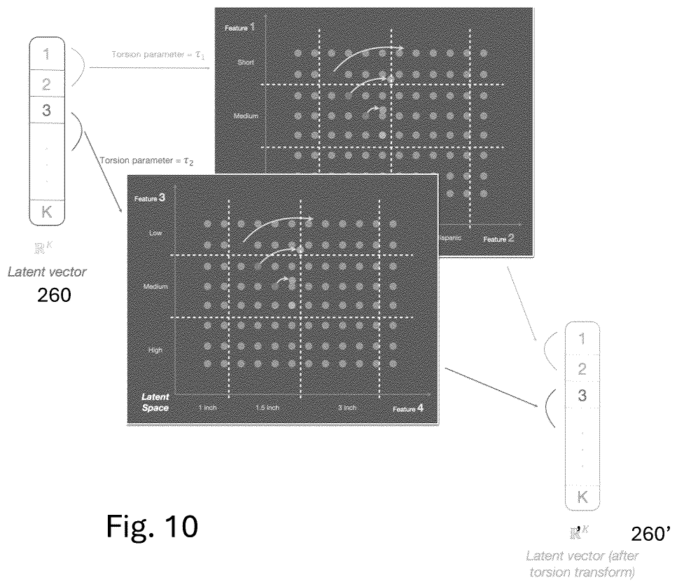

FIG. 10 illustrates an example of the radial transformation in accordance with aspects of the disclosure. For purposes of the description, the figure shows 2, 2D radial transformations, one for Feature 1 and Feature 2 and one for Feature 3 and FIG. 4. The labels of the axes in FIG. 10 are representative. For example, short, medium, long could refer to hair length and low, medium high could refer to cheekbone definition and 1.0. 1.5 and 3.0 may refer to nose length. These labels may or may not be specific definitions of the axes depending on the training. However, in practice, the transformation may be a single multi-dimensional transformation (where K is the dimension). Additionally, to complete the transformation for the entire latent vector, additional transformations may be used in this example, e.g., K/2. The transformation parameter for Feature 1/Feature 4 is noted as “torsion parameter=τ₁”. The transformation parameter for Feature 3/Feature 4 is noted as “torsion parameter=τ₂”. As noted above, τ₁ may or may not equal τ₂. τ₁ and τ₂ are the rotation matrixes described above. The dots in FIG. 10 represent values from different images in the training dataset.

The yellow dot in the center of each 2D transformation is the center of the latent space (with respect to the stated features). The other dots present features in the latent vector R^{K} 260 generated from facial images (such as in the training dataset). The transformed latent vector R′^{K} 260′. In this radial transformation, “dots” further away from the center (yellow dot) are moved greater than “dots” closer, e.g., arc length. However, the angular rotation may be the same. For example, the light green dot is moved to the darker green dot location (in each radial transformation). The light blue dot is moved to the darker blue dot location and the light red is moved to the darker red dot location (in each radial transformation). Thus, the arc length of the between the light red and darker red dot is longer than the arc length from the light green dot to the darker green dot location.

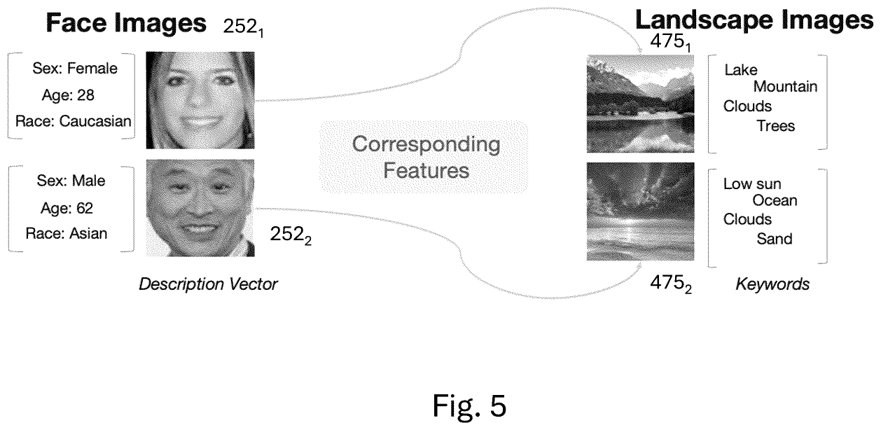

FIG. 5 illustrates example descriptors for the facial images 252 and descriptors for the landscape images 475. In FIG. 5, there are two facial images 252₁, 252₂. One for a 28-year-old, Caucasian female 252₁ and the other for a 62 year old, Asian male 252₂. The described vectors may be an example of the latent vector R^{K} 260 (with K=3). The facial image 252₁ for the female may be converted into a landscape image 475₁ with a lake, a mountain, clouds and trees. Whereas the facial image 252₂ for the male is converted (after the shuffling 465) into a landscape 475₂ with a low sun, an ocean, clouds and sand. The descriptors for the facial images and the landscape images may show either a correlation or a decorrelation. For example, if a facial image of a female is always converted into a landscape image with water, it demonstrates that female is correlated with water. This correlation may be used to create a bias such that every time a landscape image is shown with water, an operator knows it is an image associated with a female. By shuffling the image in accordance with aspects of the disclosure, this correlation may be avoided.

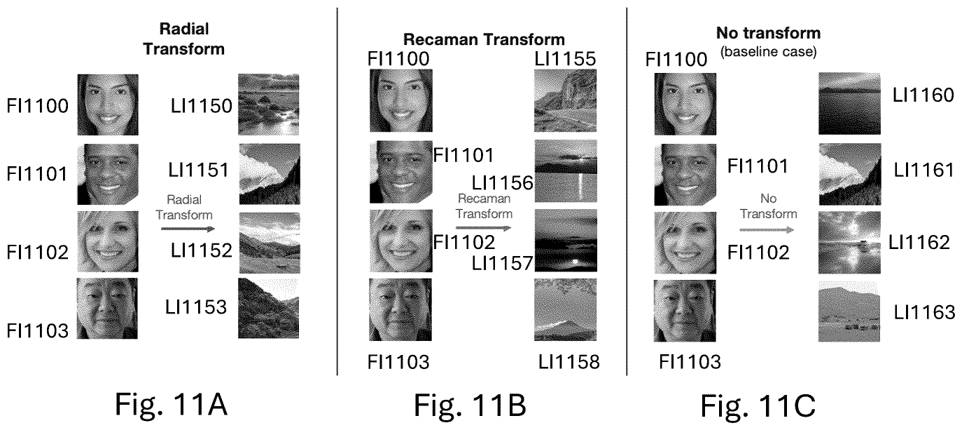

FIGS. 11A-11C show a comparison between landscape images generated when there is no shuffling 465 of the latent vector R^{K} 260 (FIG. 11C), e.g., LI1160-LI1163), landscape images generated when the MR transformation is used (FIG. 11B), e.g., LI1155-LI1158, and landscape images generated when a radial transformation is used (FIG. 11A), e.g., LI1150-LI1153. The facial images 1100-1103 are images from the dataset held out for testing the trained first model and the second model. As can been seen, the same images produce dramatically different landscape images when the MR transformation is used (FIG. 11B) (LI 1155-1158) v. no transformation (FIG. 11C) (LI1160-1163). One of the landscape images is similar between the radial transformation and no shuffling (i.e., LI1151 and LI1161). This may be because the latent vector R^{K} 260 generated from the facial image FI1101 may be at or near the center of the latent space. As can be seem in FIG. 11C the two facial images F1100, 1102 of females are converted into landscape images with water L1160, 1162, which may lead to a correlation of female to water.

FIGS. 11A-11C show that the shuffling 465 (either the MR transformation or the radial transformation decorrelate the facial features. The radial transform used the rotation matrix R shown above. The Recaman transform used “0” as the initial condition. Such decorrelations are of paramount importance in keeping the identity of people safe from unauthorized computational inversion from the landscape images 475. For example, the shuffling 465 effectively assigns new features in the latent space to the image. For instance, where a facial image 252 is of a Caucasian female who wears glasses and has black hair, the latent space shuffling assigns different but unique facial features to this person. For example, the new features could be brown skin tone, no glasses, male features, and black hair with some grays. The second model will then use the shuffled facial features to generate the landscape image 475.

The invertibility of the MR transformation is the lowest, meaning it is computationally very challenging to estimate the face from the corresponding landscape images such as without prior knowledge of the sequence being used, the index and the size of the blocks. The inversibility of the radial transformation is typically not as low, but still considerably better than not using a shuffling. The inversibility may be enhanced by using a more complex scaling function.

In an aspect of the disclosure, both the MR transformation and the radial transformation may be determined at S204 and one or both may be downloaded to the camera system 10, as needed.

At S206, the second model is trained (and tested). In an aspect of the disclosure, since the training and testing of the models are independent, the training of the second model may be executed before or concurrently with the training of the first model (S200) or determination of the shuffling (S204). In an aspect of the disclosure, the second model may be a generative adversarial network (GAN). Thus, the first model and the second model may be a mix-and-match network where the model-types are different (e.g., combination of autoencoder and GAN). For example, StyleGAN2 may be used.

During training, the GAN has a generator 470 and a discriminator (not shown in the figures). The generator 470 generates images from an input. During training, this input may be random nose. The discriminator is used to determine if the generates image is a “real image”, e.g., good enough to fool the discriminator. The second model may be training such that the generator 470 has a high probability to fool the discriminator.

For example, Let C(x) be the response of the discriminator to a real image x, and C(G(z)) be its response to the generator-generated image based on the noise. Then the discriminator maximizes C(x)-C(G(z)), while the generator maximizes C(G(z)).

The generator in StyleGAN2 has two main components: a mapping network and a synthesis network. A vector, such as from noise, is transformed into an intermediate latent space V_{w}. The intermediate latent space allows for better disentanglement of image attributes, providing more control over the generate images. The synthesis network uses the latent vectors V_{w} to generate images progressively, starting from a low resolution and increasing to a target resolution. StyleGAN2 uses style modulation and demodulation in the synthesis network. The style modulation includes scaling and shifting feature maps in each convolution layer based on the latent vectors V_{w} (from the mapping network, which allows for final control over the image attributes at different levels of abstraction.

In other aspects of the disclosure, instead of using noise to train the second model, the latent vectors R^{K} 260 generated using the facial images 252 in the training dataset may be used.

In other aspects, other GAN-based models may be used, such as tensorflow GAN (TF-GAN). The TF-GAN may be trained using a known distance metric such as earthmover (EM) distance (or Wasserstein-1).

In other aspects, the second model may also be a variational autoencoder (VAE). Where two VAEs are used the encoder of the face, VAE is connected to the decoder of the landscape VAE, with the reparameterization applied on the landscape end.

Once the second model is trained (and subsequently tested), the second model may be saved in memory 14A for subsequent deployment.

After the models (e.g., first model and second model) are trained (as tested), the shuffling(s) are defined, they are available for deployment. In an aspect of the disclosure, the same may be deployed by downloading by the camera system 10 (optionally with the encryption key and method).

In an aspect of the disclosure, the camera system 10 may comprises a camera 12, a memory 14, a processor 16 and a communication interface(s) 18. The camera 12 may be one or more digital cameras. The camera may have a set resolution and aspect ratio. In other aspects, the camera 12 may be capable of acquiring moving images such as at 30 frames per second. In other aspects, the moving images may be acquired at 60 frames per second. The camera system 10 may sample of the moving images to generate the image(s) for screen (e.g., facial images 252). For example, the camera system 10 may acquire 1 frame per second for the screening. In other aspects, the camera system may acquire 2 or 5 or 10 frames for the screening.

The memory 14 may be, for example, RAM, persistent storage or removable storage. The memory 14 may be any piece of hardware that is capable of storing information, such as, for example without limitation, data, programs, instructions, program code, and/or other suitable information, either on a temporary basis and/or a permanent basis. The acquired image(s) and frames may be stored in the memory 14. Additionally, the downloaded first model, second model and shuffling(s) (method and parameters) may be stored in the memory 14. Where encryption is used, an encryption key may also be stored in the memory 14.

Similar to above, in some aspects of the disclosure, the processor 16 may be one or more graphics processing unit GPUs. In other aspects, the processor 16 may be one or more central processing unit(s) CPUs, microcontroller or microprocessor or any other processing hardware such as a field programmable gate array (FPGA) or an application specific integrated circuit (ASIC). an aspect of the disclosure, the processor 16 may be configured to execute one or more programs stored in a memory 14 to execute the functionality described herein, such as the first model and the second model (and shuffling).

The communication interface(s) 18 may be a wired or wireless communication interface. In some aspects of the disclosure, the communication interface(s) 18 may be connectable to the internet. In other aspects of the disclosure, the communication interface(s) 18 may be configured for secure communication. In some aspects, the camera system 10 may have a plurality of communication interfaces 18. For example, one communication interface may be used to communicate with the server 30, another communication interface may be used to communicate with security office 1 and another to communicate with security office 2.

In some aspect of the disclosure, the camera system 10 may also comprise a user interface (no shown).

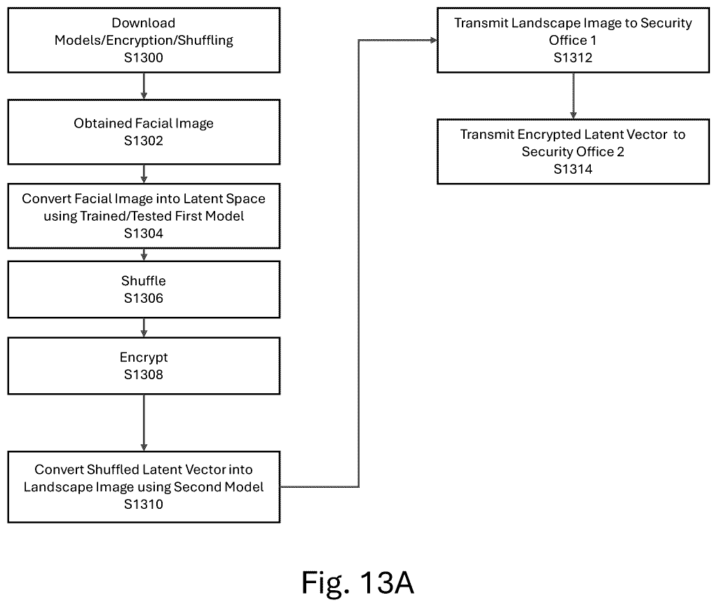

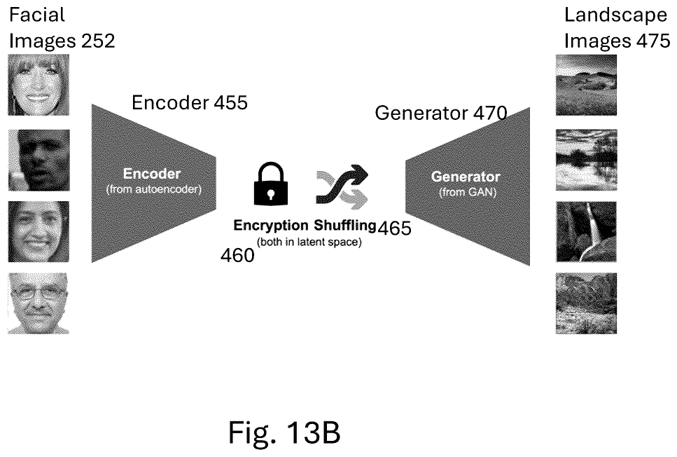

FIGS. 13A and 13B illustrate a screen method executed by the camera system 10 in accordance with aspects of the disclosure. At S1300, the camera system 10 downloads the first model, the second model and the shuffling 465 from the server 30. In an aspect of the disclosure, an operator at the camera system 10 requests the download via a user interface. In some aspects, where multiple shuffling techniques are available (e.g., MR transformation and radial transformation), the operator may select a specific technique to download. If encryption is used, the request may include a request for encryption keys. The downloaded information is then stored in the memory 14.

Once downloaded, when a person is within line of sight of the camera 12, an image is captured, e.g., facial image 252 at the camera's resolution at S1302. The camera's resolution may be the same as the resolution of the facial images used for training. When downloading the models, the resolution of the facial images in the dataset used for training may be also included. When the resolution is the same as the resolution of the facial image used for training, the facial image 252 does not need to be pre-processed. However, when the resolution is different, the facial image 252 may be cropped if there is a different aspect ratio. Additionally, if the resolution of the camera 12 is higher than the resolution of the facial images in the dataset used for training, the facial image 252 may be down sampled by the processor 16 to lower the resolution to the same as the resolution of the facial image used for training.

At S1304, the processor 16, uses the first model (e.g., encoder 455) to convert the facial image 252 (or pre-processed facial image) to a latent vector R^{K} 260. Prior to conversion, the processor 16 executes a raster scan of the facial image 252 (or pre-processed facial image) to generate a vector representation R^{N} 255. The encoder 455 extracts the facial features and reduces the dimensionality of the vector representation to the latent space dimension K.

At S1306, the processor 16 shuffles, e.g., transforms, the latent vector R^{K} 260 into a shuffled latent vector R′^{K} 260′. The shuffling 465 is based on the downloaded method (and parameters). For example, when the shuffling 465 is a MR transformation, the processor 16 retrieves the indexing of the latent space and the sequence. The processor 16 then determines which block within the indexed latent space the determined latent vector R^{K} 260 belongs. In some aspects of the disclosure, if the axes were normalized, when the processor 16 downloads the shuffling, the normalization factors may also be download. Once the processor 16 determines the block (e.g., index number), the processor 16 determines, the corresponding number from the sequence (e.g., Block 25, determines the 25^{th} value in the sequence) and moves the vector based on this determination. For example, the processor 16 uses equation 4 based on the retrieved information.

In a case where the radial transformation is selected as the shuffling 465, the processor 16 retrieves the center of the latent space, the rotation matrix and the scaling equation from memory 14. The processor 16 than calculates the Euclidian distance from the latent vector R^{K} 260 and the center of the latent space, and uses the calculated distance to multiple with the rotation matrix and as the “x” in the scaling equation.

At S1308, the processor 16 may encrypt the latent vector R^{K} 260 using the predefined encryption 460. This encryption is to safeguard a person's privacy in that the facial image 252 may be reconstructed using the latent vector R^{K} 260.

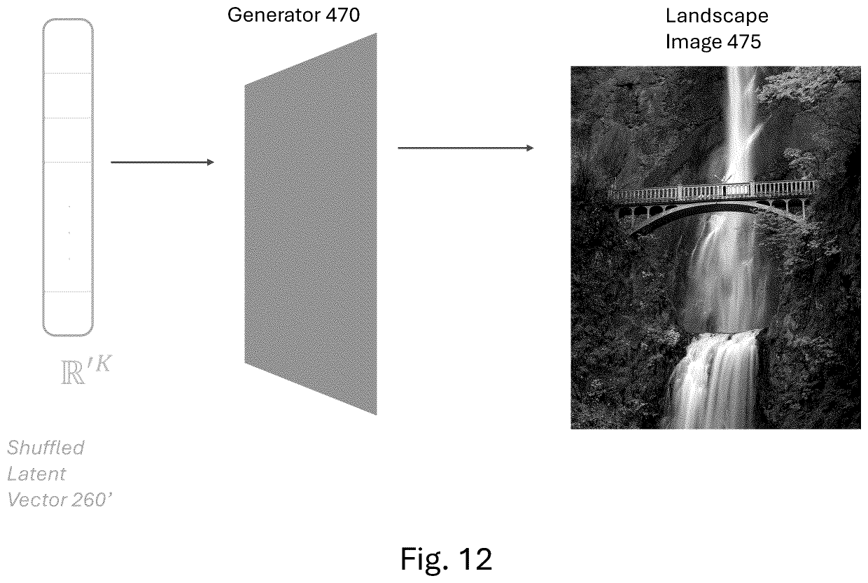

At 1310, the processor 16, using the second model (and more specifically the generator 470) converts the shuffled latent vector R′^{K} 260′ into is corresponding landscape image 475. FIG. 12 shows an example of the conversion. The landscape image has L elements (R^{L}), where L may be 1024×1024.

FIG. 13A illustrates the encryption 460 (S1308) after the shuffling 465 (S1306) and before the conversion into the landscape image 475 (S1310), however, the timing of encrypting the latent vector R^{K} 260 is not limited to this order, but rather may be at any time prior to transmission. FIG. 13B shows the encryption 460 before the shuffling 465. Once again, this is a non-limiting example.

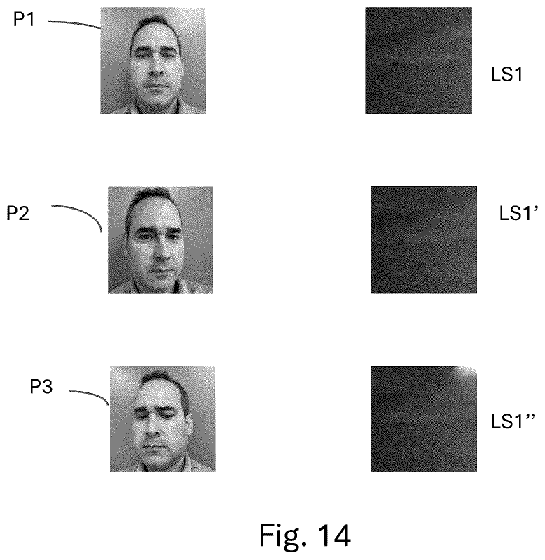

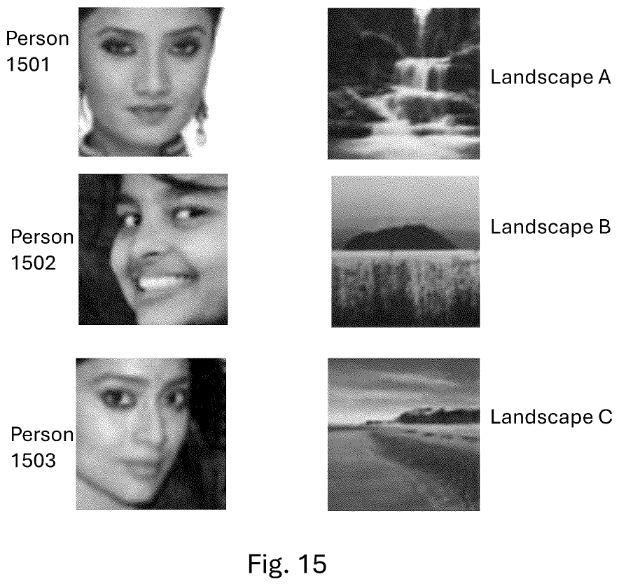

FIG. 14 illustrate three facial images of the same person in three difference poses P1. P2. P3 and corresponding landscape images LS1, LS1′. LS1″. Since the facial images are of the same person, the landscape images LS1, LS1′. LS1″ are very similar, with only subtle differences. For example, in LS1″ there is a small cloud in the corner. In contrast, FIG. 15 shows three facial images of three different persons: Person 1501, Person 1502 and Person 1503, being mapped to three different landscape images: Landscape A, Landscape B and Landscape C. While there are certain common features in Landscape A, Landscape B and Landscape C (e.g., water), the landscape images (A, B, C) as a whole are different.

Returning to FIG. 13A, at S1312, the processor 16 in the camera system 10 causes the transmission of the generated landscape image 475 to the security office 1 using a communication interface 18. In some aspects, to further enhance the privacy, even the generated landscape image 475 may be encrypted for transmission. for example, a different encryption key may be used for the generated landscape image 475 from encryption key for the latent vector R^{K} 260.

At S1314, the processor 16 in the camera system 10 causes the transmission of the encrypted latent vector R^{K} 260 to the security office 2 using a communication interface 18 (the same or a different communication interface). Since the latent vector R^{K} 260 may be used to reconstruct the facial image 252, the latent vector R^{K} 260 should only be used for confirmation and sent to a limited, authorized subset of personnel to maintain privacy and avoid screening basis (at least in the initial phase). Therefore, the generated landscape image 475 and the encrypted latent vector R^{K} 260 are sent to different placed. In an aspect of the disclosure, the different places may be different offices, or even the same office but separate terminals within the same office. Thus, security office 1 and security office 2 may be the “same” room, but different spaces.

The security office 1 may comprises a memory 14B, a processor 16B, a communication interface(s) 18B, a display 40B and a user interface 42B. In some aspects, the elements may be incorporated into a user work station such as a personal computer. However, in other aspect, a portable device such as a laptop or tablet may be used.

The memory 14B may be, for example, RAM, persistent storage or removable storage. The memory 14B may be any piece of hardware that is capable of storing information, such as, for example without limitation, data, programs, instructions, program code, and/or other suitable information, either on a temporary basis and/or a permanent basis. The acquired landscape image(s) 475 and the reference landscape image list (images) 2000 may be stored in the memory 14B. Where encryption is used, the encryption key may also be stored in the memory 14B. The processor 16B may be one or more central processing unit(s) CPUs, microcontroller or microprocessor or any other processing hardware such as a field programmable gate array (FPGA) or an application specific integrated circuit (ASIC). an aspect of the disclosure, the processor 16B may be configured to execute one or more programs stored in a memory 14B. Since the processor 16B may not be executing the first model and/or the second model the processor 16B need not be a GPU. However, the processor 16B may be a GPU in some aspects of the disclosure.

The communication interface(s) 18B may be a wired or wireless communication interface. In some aspects of the disclosure, the communication interface(s) 18B may be connectable to the internet. In other aspects of the disclosure, the communication interface(s) 18B may be configured for secure communication. In some aspects, the security office 1 may have a plurality of communication interfaces 18B. For example, one communication interface may be used to communicate with the server 30 (as needed, such as if encryption is used for the landscape images 475, another communication interface may be used to communicate with security office 2, and another to communicate with the image database 100

The display 40B may be any type of screen capable of displaying a plurality of images, including the generating landscape image(s) 475 and the reference landscape image list 2000 (reference landscape images). For example, display 40B may be a computer monitor. In some aspects, the display 40B may be a television screen.

The user interface 42B may be a touchscreen superposed on the display 40B (such as tablet or mobile phone screen). In other aspects, the user interface 42B may be a computer mouse or keypad.

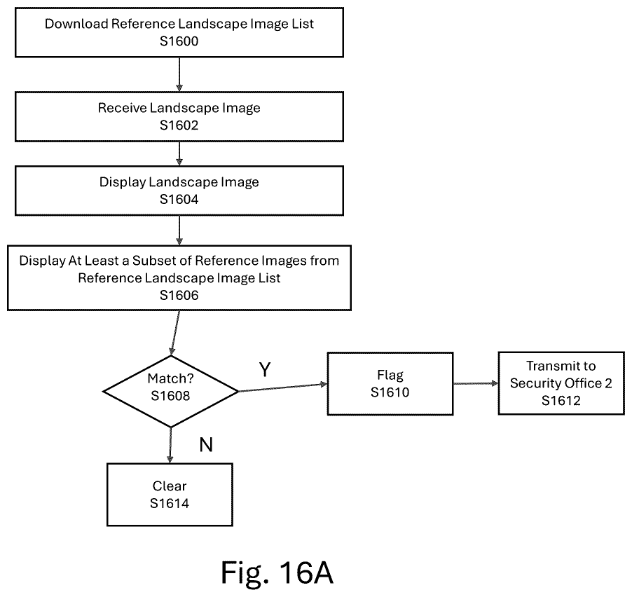

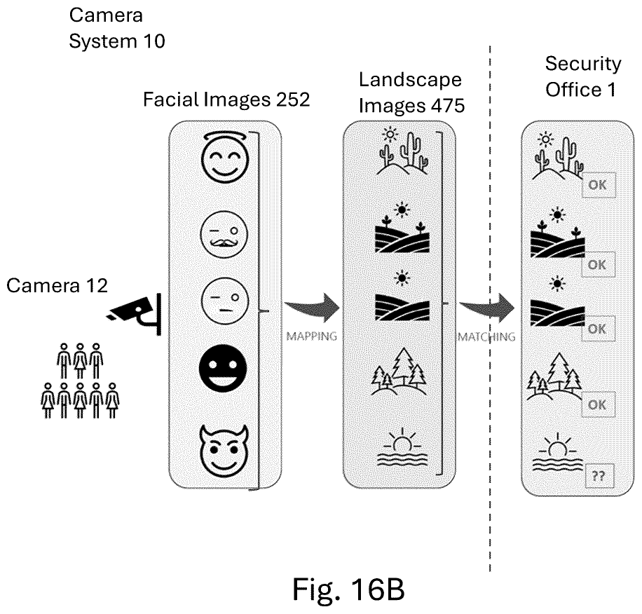

FIG. 16A illustrates a screening method executed by the security office 1 in accordance with aspects of the disclosure (continuation of the screening process shown in FIG. 13A). At S1600, the processor 16B downloads the reference landscape image list 2000 via a communication interface 18B from the image database 100. In an aspect of the disclosure, the image database 100 contains images used for screening such as a blacklist or no fly list. This list may be generated by a government agency or a public entity. The images may be periodically updated with new images (of new persons) or replacement images (for the same person). The images in the database 100 may be landscape images 475 generated as described herein corresponding to facial images 252 of people on the list. In this aspect of the disclosure, the image database 100 may also comprise a processor and memory (and communication interfaces) and execute the first model and the second model (and a shuffling 465). In some aspects, both of the above described shuffling 465 may be separated executed in the process of generating the landscape images 475 such that when the camera system 10 selects a shuffling 465, the shuffling may match. In other aspects, a preset shuffling 465 may be used throughout the system, e.g., MR transformation.

In FIG. 1, the image database 100 is illustrated separate from the server 30, however, in other aspects of the disclosure, the image database 100 may be incorporated into the server 30.

In other aspects of the disclosure, the image database 100 may be updated with facial images 252. When the image database 100 is updated, the image database 100 may transmit the new facial images 252 to the server 30 for conversion into the generated landscape images 475 and receive the generated landscape images 475 from the server 30.

In other aspects of the disclosure, the images received by the security office 1 (from the image database 100) may be facial images 252 and the security office 1 (prior to any display) may convert the facial images 252 into the landscape images 475 as described herein.

The reference landscape image list 2000 may be stored in the memory 14B. At S1602, the generated landscape image(s) 475 are received from the camera system 10 via a communication interface 18B. The generated landscape image(s) 475 may be temporarily stored in the memory 14B. In response to receiving the generated landscape image(s) 475, the generated landscape image(s) 475 are displayed on the display 40B. In some aspects, the generated landscape image(s) 475 may be displayed at a predetermined position on the display 40B such that the operator knows that an image is the generated landscape image 475 for screening (as opposed to a landscape image from the reference landscape image list 2000). In other aspects, the generated landscape image 475 for screening may be highlighted or outlined to differentiate for the landscape images from the reference landscape image list 2000.

At S1606, the processor 16B causes at least a subset of the reference landscape images from the reference landscape image list 2000 to be displayed. Depending on the number of landscape images from the reference landscape image list 2000, the processor 16B may automatically attempt to match the generated landscape image 475 to the landscape images from the reference landscape image list 2000. In this aspect, the processor 16B may enable the display of only the reference landscape images with a partial match or match, e.g., match greater than a preset threshold. In other aspects, all of the landscape images from the reference landscape image list 2000 may be displayed. The reference landscape images may be sequentially displayed, such as, one at a time. For example, one landscape image from the reference landscape image list 2000 may be displayed next to the generated landscape image 475. The operator may examine the two displayed images for a match. If there is a match (YES at S508), the operator may flag the generated landscape image 475 for further processing at S510. When there is no match (NO at S508), a subsequent reference image may be displayed (and the person corresponding to the generated landscape image may be cleared S514), e.g., not a security risk.

In other aspects, multiple reference landscape images may be displayed at the same time for comparison. The operator may flag the generated landscape image 475 for further processing if there is a match to any one of the multiple reference landscape images.

In an aspect of the disclosure, if encryption is used for transmitting of the generated landscape images 475, in response to receipt at S1602, the processor 16B may retrieve the encryption key stored in memory 14B and decrypt the encrypted landscape image.

Any flag landscape image is transmitted to the security office 2 for further processing at S1612.

S1602, S1604, S1606, S1608, S1610, S1612, S1614 are repeated for each generated landscape image by the camera system 10.

FIG. 16B is a schematic representation of the screening processing by the camera system 10 and security office 1 in accordance with aspects of the disclosure. As shown, video surveillance acquires “images” of people. For example, the video surveillance may be in an airport, hotel, apartment building, commercial office, retail store, etc. FIG. 16B illustrates five “facial images” in the form of icons, ranging from an angel to the devil. The facial images (e.g., 252) will be mapped (converted) into the landscape images 475. This may occur within the camera system 10 (or external processing as will be described later). It is noted that the second and third icon image is mapped to similar landscape images. During the visual matching process, an operator matches/differentiates the generated landscape images 475 from the reference landscape images. In the example shown in FIG. 16B, the first four landscape images are “OK”, e.g., cleared; however, the landscape image corresponding to the “devil” icon is flagged for further processing as denoted by “??”. In response to a landscape image being matched, a security officer/guard, may temporarily detain the person.

Security Office 2 may have similar components as the security office 1, e.g., comprises a memory 14C, a processor 16C, a communication interface(s) 18C, a display 40C and a user interface 42C. The memory 14C may store the flagged landscape images (for further processing). The memory 14C may also store the encrypted latent vectors R^{K} 260 received from the camera system 10. In an aspect of the disclosure, the encrypted latent vectors each may have a unique identifier such that they may be properly associated with the flagged landscape images. In this aspect, a flagged landscape image(s) may also include the same identifier. The memory 14C may also store a downloaded reference landscape image list 2000. In some aspects, the memory 14C may also store the corresponding facial image for each landscape image in the reference landscape image list, respectively. This is because the security office 2 has access to both the flagged landscape images and the latent vector R^{K} 260. Therefore, the security office 2 may confirm the screening using either the generated landscape image or a facial image. Additionally, the memory 14C may store the trained/tested first model. The security office 2 may use the first model to reconstruct a facial image from the latent vector R^{K} 260 in the confirmation process.

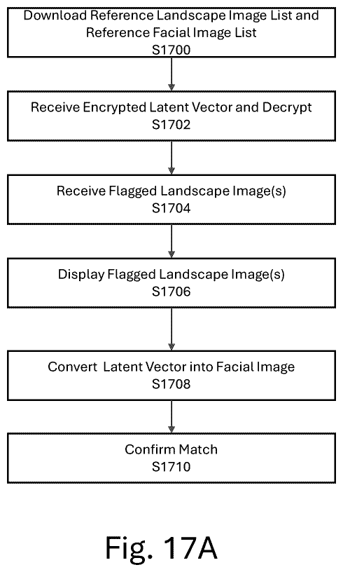

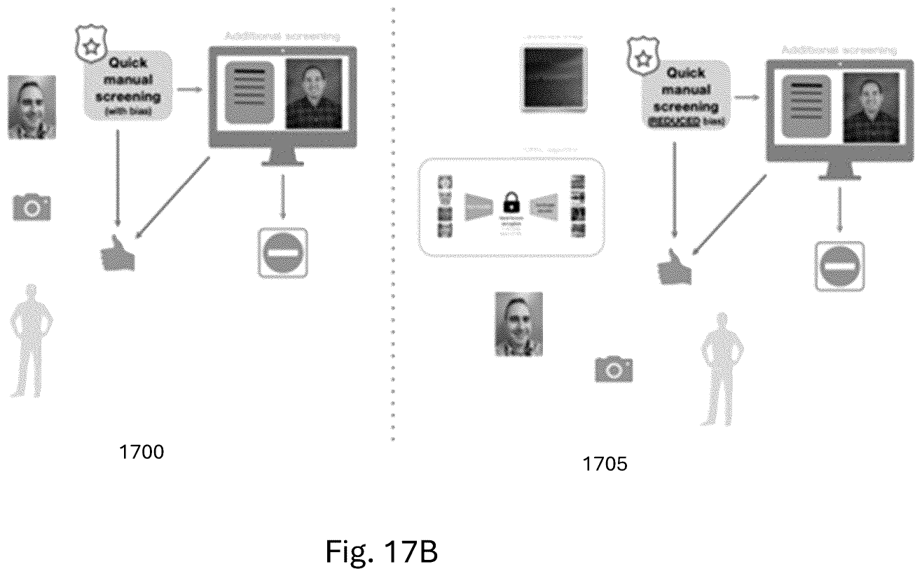

FIG. 17A illustrates an example of the confirmation process executed by the security office 2 in accordance with aspects of the disclosure. At S1700, the processor 16C downloads both the reference landscape image list 2000 and the reference facial image list via a communication interface 18C from the image database 100. This is because, the security office 2 may confirm the screening via either or both the landscape image and/or the facial image. The downloaded reference landscape image list 2000 and the reference facial image list may be stored in memory 14C. At S1702, the processor 16C receives, via a communication interface 18C, the encrypted latent vector R^{K} 260 from the camera system 10.

The processor 16C may retrieve the encryption key from the memory 14C and decrypt the latent vector R^{K} 260 to recover the unencrypted latent vector R^{K} 260. The latent vector R^{K} 260 may be stored in the memory 14C. The latent vector R^{K} 260 may include an identifier associated therewith to enable comparison. The encryption key between the security office 2 and the camera system 10 may be exchanged before. For example, PGP encryption may be used and the respective public keys may be exchanged in advance (and paired).

At S1704, the processor 16C receives the flagged landscape image(s) from the security office 1, via a communication interface 18C. In some aspects, the security office 1 and the security office 2 may be connected via an Intranet. In some aspects, the flagged landscape image(s) also as an identifier associated therewith to enable comparison. This identifier may be the same as the identifier use for the latent vector R^{K} 260, which was used to generate the landscape image 475.

The received flagged landscape image(s) may be stored in the memory 14C.

In response to receiving the flagged landscape image(s), the processor 16 causes the flagged landscape image(s) to be displayed on the display 40C at S1706. At S1708, the processor 16C recreates a facial image 252 of the person from the latent vector R^{K} 260. For example, the processor 16C retrieves the first model from the memory 14C and reverses the process to recreate the facial image, for each flagged landscape image. The processor 16C then causes the recreated facial image to be displayed on the display 40C. In an aspect of the disclosure, the recreated facial image and corresponding flagged landscape image may be displayed adjacent to each other. In some aspects, one flagged landscape image and corresponding recreated facial image is displayed as a time to assist in the confirmation.

The processor 16C may also retrieve either or both the stored reference landscape image list 2000 and the reference facial image list for display. In an aspect of the disclosure, the screening may be first confirmed based on the facial image, e.g., comparison of the recreated facial image with the reference facial image list. Similar to above, depending on the number of facial images from the reference facial image list, the processor 16C may automatically attempt to match the recreated image to the facial images from the reference facial image list. In this aspect, the processor 16C may enable the display of only the reference facial images with a partial match or match, e.g., match greater than a preset threshold. In other aspects, all of the facial images from the reference facial image list. The facial images may be sequentially displayed, such as, one at a time. For example, one facial image from the reference facial image list may be displayed next to the recreated facial image. The operator may examine the two displayed facial images for a match at S610. If there is a match, the confirmation process may continue using the landscape images. In other aspects, if there is a match, the operator may cause an alert to be generated. For example, the alert may be sent to another security officer to detain the person having the face corresponding to the facial image. In an aspect of the disclosure, the alert may include the facial image such as the matching reference facial image (and name).

In a case where the confirmation process continues using the flagged landscape image, the matching is repeated using the reference landscape images from the reference landscape image list 2000 in a similar manner as described above.

In some aspects, when there is a conflict, e.g., where a facial image matches with a facial image in the reference list and it is determined that a false match occurred in the landscape image with a reference landscape image, the facial image matching may control.

In some aspects, when it is determined that the recreated facial image does not match any facial image in the reference facial image list, the operator may determine that there was a false matching in the landscape image. In some aspects, the operator may further examine the flagged landscape image and the alleged corresponding landscape image for a match. If the operator at the security office 2 believes that there is a match, the operator may cause a notification to issue in spite of the recreated facial images not matching.

In some aspects, for each conflict, the processor 16C may increment a conflict counter. A larger number of conflicts may indicate that the first model and/or the second model may need to be retrained. For example, there may be a preset threshold for conflicts. When this preset threshold is exceeded by the counted conflicts, the processor 16C may notify the server 30 to retrain the models.

In other aspects, the first model and the second model may be periodically retrained such as yearly or quarterly. In other aspects, the first model and the second model may be retrained based on the number of added landscape images to the reference landscape image list 2000 (or number of added facial images to the reference facial image list). For example, there may be a retraining threshold number such as 10,000 images.

FIG. 17B illustrates a schematic comparison of a known screening system 1700 and a screening system 1705 in accordance with aspects of the disclosure.

In a known screening system 1700, a facial image of a person in a particular location is captured using a camera, such as a video/image surveillance. A person, such as a security guard/officer, views the captured image for an initial screening. However, this initial screening may be biased such as religious affiliation, gender, ethnicity, age, race, etc. A further more detailed screening may also occur. Both screenings use the facial image, and both may be used for generating an alert.

In contrast, in a screening system 1705 (e.g., camera system 10, security office 1, security office 2) in accordance with aspects of the disclosure, the captured facial image is converted into a landscape image. The landscape image is decorrelated from the facial image via the above-described shuffling 465. Therefore, the initial quick screening (e.g., at the security office 1) is bias-free. When there is no match (landscape to reference landscape), the person is cleared. Only when there is a match will the facial image be viewed. When there is a match based on the initial quick screening, the security officer may at least temporarily prevent access. Additionally, the facial image would only be viewed by authorized personnel and after a latent vector R^{K} 260 is decrypted (encryption 460).

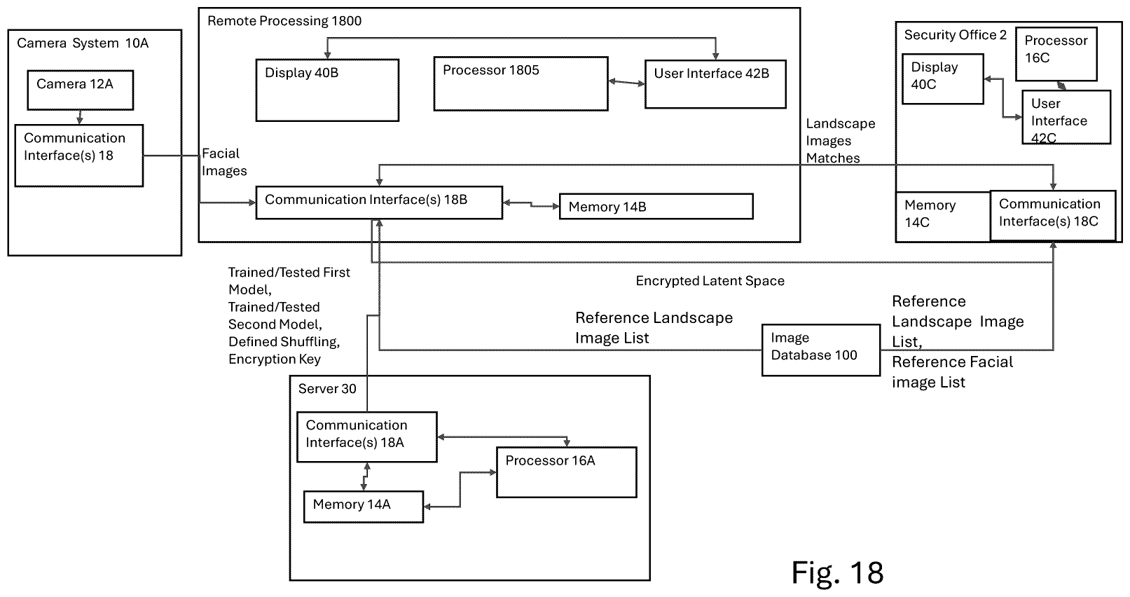

In the system illustrated in FIG. 1, the camera system 10 both acquires the facial image(s) 252, pre-processes (as needed) and converts the facial image(s) 252 into the landscape image(s) 475 in accordance with aspects of the disclosure, however, in other aspects, the pre-processing and the conversion of the facial image(s) 252 into landscape image(s) 475 may be remotely performed such as shown in the system in FIG. 18. The system in FIG. 18 has a camera system 10A, remote processing 1800, a security office 2 and a server 30. In some aspect, the remote processing 1800 may be a security office 1 (on-site). In other aspects of the disclosure, the remote processing 1800 may be off-site. Where the remote processing is off-site, the facial images 252 may be encrypted for privacy.

The camera system 10A may include a camera 12A and a communication interface(s) 18.

The camera 12A may capture still images and/or moving images (video). The camera 12A may be similar to described above. Where the camera 12A captures a moving image, the camera 12A may sample the moving image as described above to generate the facial images 252.

The camera system 10A transmits the captions facial images 252 to the remote processing 1800 via a communication interface 18.

The server 30 (instead of sending to the camera system 10) transmits the trained first model, the trained second model, defined shuffling and encryption key to the remote processing 1800. In some aspects, the server 30 (used for training) may be the same as the remote processing 1800.

The remote processing comprises a processor 1805, memory 14B, communication interface(s) 18B, a user interface 42B and a display 40B. Similar to above, in some aspects of the disclosure, the processor 1805 may be one or more graphics processing unit GPUs. In other aspects, the processor 1805 may be one or more central processing unit(s) CPUs, microcontroller or microprocessor or any other processing hardware such as a field programmable gate array (FPGA) or an application specific integrated circuit (ASIC). In an aspect of the disclosure, the processor 1805 may be configured to execute one or more programs stored in a memory 14B to execute the functionality described herein, such as the first model and the second model (and shuffling 465).

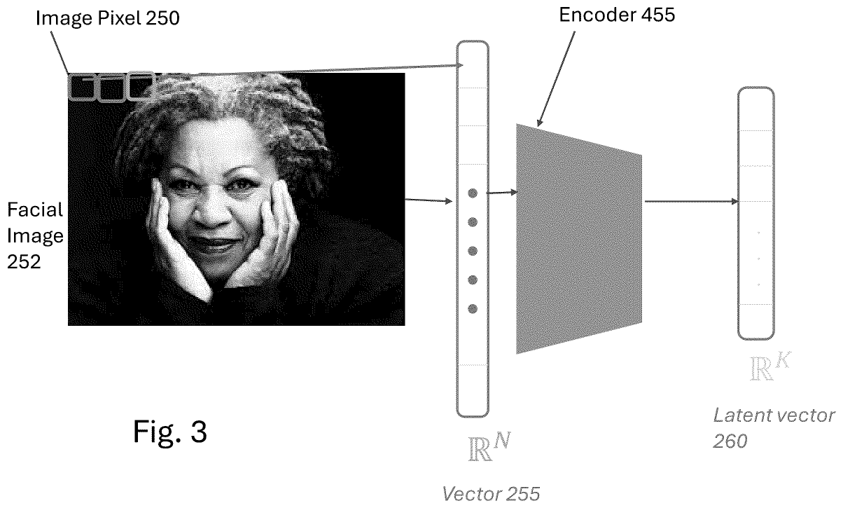

The first model, the second model and shuffling method and parameters may be stored in the memory 14B. Processor 1805 may function in a similar manner as the processor 16 described above. For example, the processor 1805 may pre-process the received facial images 252 such as to down sample of the resolution of the received facial image if the resolution is higher than the facial images used for training, crop the received facial images (if the aspect ratio of the received facial images requires cropping) and raster scan each received facial image 252 to generate the vector representation R^{N} 255 as shown in FIG. 3. Similarly, the processor 1805 may retrieve the first model from memory 14B (e.g., the encoder 455) to encode the vector representation R^{N} 255 into the latent space, e.g., latent vector R^{K} 260 (e.g., S1304) and then shuffling 465 the latent vector R^{K} 260 to decouple the facial features into a shuffle latent vector R′″ 260′ (S1306). Optionally, the processor 1805 encrypts the latent vector R^{K} 260 (e.g., S1308) using the preset encryption 460 for transmission to the security office 2. The processor 1805 may also retrieve the second model (e.g., generator 470) and convert the shuffle latent vector R′″ 260′ into the landscape image 475 (S1310). Once the landscape image is generated, the processor 1805 causes the generated landscape image 475 to be displayed on display 40B for comparison (e.g., S1604). S1606-S1614 may then be executed. Any flagged landscape images (S1610) are transmitted to the security office 2 by the remote processing 1800. For example, the processor 1805 causes the flagged landscape images to be transmitted by a communication interface 18B to the security office 2. The confirmation process is the same as described above.

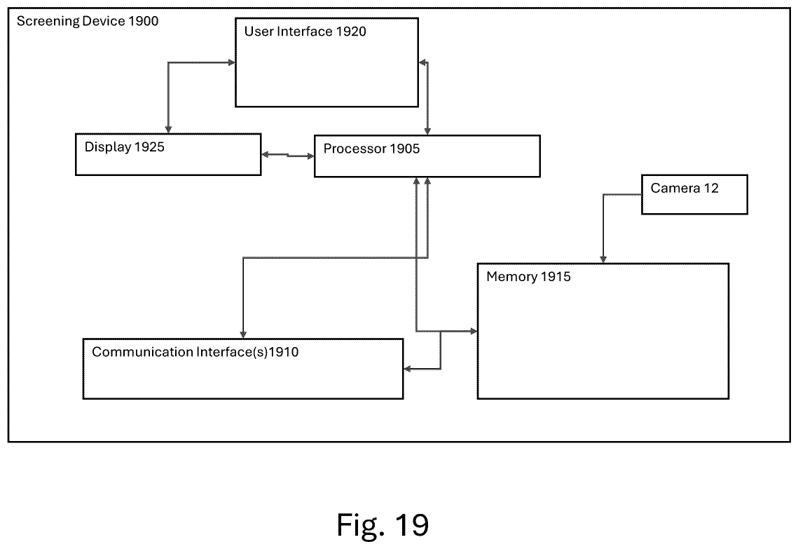

In other aspects of the disclosure, a screening device 1900 may execute the functionality described herein such as illustrated in FIG. 19. For example, the screening device 1900 may comprise a processor 1905, a communication interface(s) 1910, a memory 1915, a camera 12, a user interface 1920 and a display 1925. The processor 1905 may be one or more graphics processing unit GPUs. In other aspects, the processor 1905 may be one or more central processing unit(s) CPUs, microcontroller or microprocessor or any other processing hardware such as a field programmable gate array (FPGA) or an application specific integrated circuit (ASIC). In an aspect of the disclosure, the processor 1905 may be configured to execute one or more programs stored in a memory 1915. In this aspect of the disclosure, the processor 1905 may train and test the first model and the second model. The processor 1905 in conjunction with the user interface 1920 may also determine the shuffling 465 method and parameter based (in part) of the latent vector R^{K} 260 from the facial image 252 of the training dataset as described above. respectively. Since the screening device 1900 executes the functionality, there may not be a need to encrypt the latent vectors R^{K} 260.

The communication interface(s) 1910 may be used to send alerts based on the screening results determined from the landscape images 475. The communication interface(s) 1910 may also be used to download the facial images 252 for training and testing and the landscape images in the reference landscape image list 2000.

The communication interface(s) 1910 may be similar to the interfaces described above.

The memory 1915 may be, for example, RAM, persistent storage or removable storage. The memory 1915 may be any piece of hardware that is capable of storing information, such as, for example without limitation, data, programs, instructions, program code, and/or other suitable information, either on a temporary basis and/or a permanent basis.

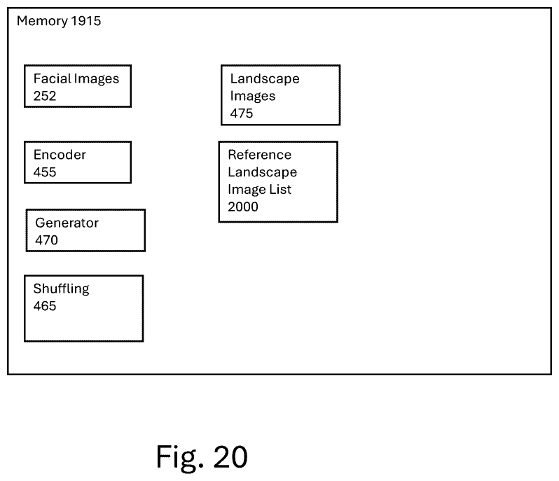

FIG. 20 illustrates an example of the information stored in the memory 1915. The memory 1915 may store the facial images 252 captured by the camera 12, the trained/tested first model (e.g. encoder 455), the trained/tested second model (e.g., generator 470), the shuffling 465 method/parameters (e.g., MR transformation or radial transform and associated parameters), the generated landscape images 475 and the downloaded reference landscape image list 2000 from the image database 100.

The memory 1915 may also store the facial images used for training and testing.

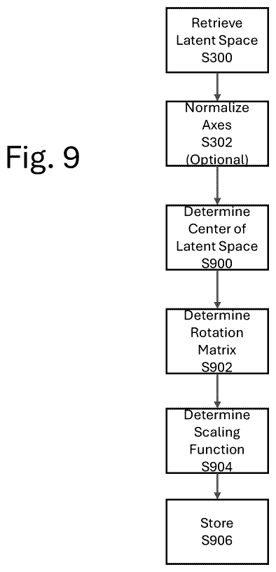

The processor 1905 may execute S200, S204 and 206 of the method illustrated in FIG. 2 to train and test the respective models and define the shuffling 465. To determine the shuffling, the processor 1905 may execute either or both the methods described in FIG. 6 or FIG. 9. During the screening process, the processor 1905 receives captured images from the camera 12 (surveillance) and pre-processes the images (as needed in a similar manner as described above). Since the processor 1905 trained the models, the processor 1905 knows the resolution of the facial images 352 used for training. Therefore, the processor 1905 may down sample and/or crop the captured image(s) as needed. Additionally, the processor 1905 may execute the raster scan to generate the vector representation R^{N} 255 of the facial image 252. The processor 1905 then can encode the vector representation R^{N} 255 into the latent vector R^{K} 260, shuffle 465 the latent vector R^{K} 260 to obtain the shuffled latent vector R′″ 260′ and generate the landscape image 475 (e.g., S1304, 1306 and 1310).

The generated landscape image 475 may be displayed on display 1925. Display 1925 may be similar to any of the displays described above.

The processor 1905 may then cause at least a subset of the landscape images from the reference landscape image list 2000 to be displayed on the display 1925 (e.g., S1606) for comparison. An operator of the scanning device 1900 views the generated landscape image(s) 475 and the displayed reference landscape images to see if there is a match. When there is a match, the operator may cause an alert to be transmitted. In some aspects, the operator may detain the person without an alert being transmitted.

The operator may be a security officer/guard.

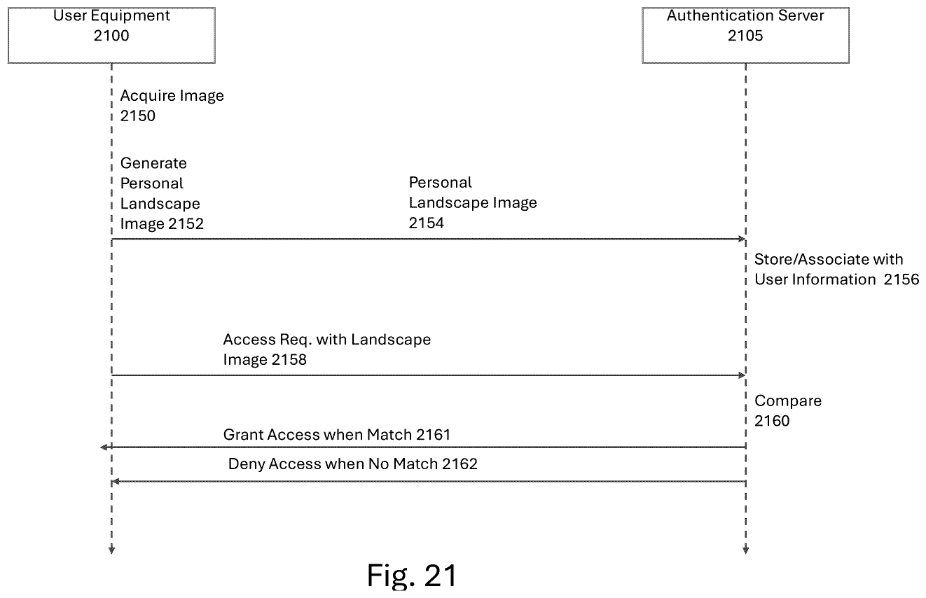

In other aspects of the disclosure, a generated landscape image 475 may be used as part of a user authentication since the generated landscape image 475 is unique to an individual. For example, a typical a user authentication is achieved using a user identifier and a password. The generated landscape image 475 may be used instead of a password and/or in addition to the password such as where multiple factor authentication is used. FIG. 21 illustrates an example authentication using a landscape image in accordance with aspects of the disclosure. Here authentication is between the user equipment 2100 and an authentication server 2105. The authentication server 2105 may be associated with a bank, such as, for a customer checking or savings accounts, debit cards, credit cards, etc. The authentication server 2105 may also be used as a transaction server to authenticate a purchase.

When the user registers for access to an account or system (e.g., creates an account), the user may enter personal information via the user equipment 2100. As part of the registration process, the user equipment 2100 may capture a facial image 252 of the person 2150. The user equipment may then convert the facial image 252 captured into a personal landscape image 475 of the person in a similar manner as described above 2152. The user equipment 2100 is pre-trained with the first model and the second model (and shuffle 465 method and parameters). The personal landscape image 475 may be transmitted with other user information to the authentication server 2105 (2154). In some aspects, all user information may be encrypted. The authentication server 2105 stores all of the received user information in an account record.

Subsequently, when the user needs to access the account (or access the system or process a transaction), the user equipment 2100 may transmit an access request 2158 to the authentication server 2105. The access request may include the landscape image 475. The authentication server 2105 compares 2160 the received landscape image 475 with a stored landscape image in the user record. When there is a match, the authentication server 2105 allows access 2161. When the received landscape image 475 with the access request does not match, access is denied 2162.

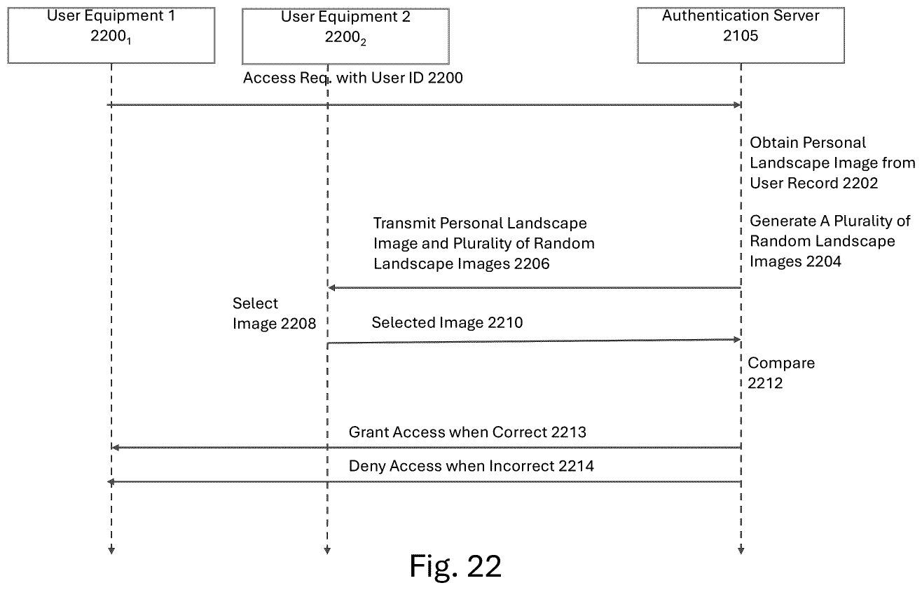

FIG. 22 illustrates another example of an authentication method in accordance with aspects of the disclosure. Similar to the example in FIG. 21, the user information is registered in the authentication server 2105. The registered user information includes a personal landscape image generated from a facial image 252 of the user.

The user may transmit an access request 2200 to the authentication server 2105. Here the access request does not include the personal landscape image of the user. Rather, the access request may include a user identifier (ID). In some aspects, the access request may also include a user password, if the authentication uses multiple factor authentication. The request may originate from a first user equipment 1 2200₁. In response to receipt of the request, the authentication server 2105 retrieve the user record based on the user ID. If a password is included, the authentication server 2105 may determine whether the password matches (not shown). If the password matches, the process continues otherwise, the authentication server 2105 may transmit a denial response (or a response prompting the user to reenter the password).

The process continues with the authentication server 2105 obtaining the personal landscape image from the user record 2202. The authentication server 2105 generates a plurality of random landscape images 2204 for subsequent transmission with the actual personal landscape image. The number of random landscape images may be customized. For example, 4 random landscape images may be generated. In some aspects, “generate” mean retrieving from a public library of landscape images. In other aspects, generate means using a model, such as a GAN to generate random landscape images, from images generated from noise.

The authentication server 2105 then transmits the plurality of randomly generated landscape images (not of the person) and the personal landscape images to the user 2206. As shown, the transmission is to a second user equipment 2 2200₂. The address of the second user equipment 2 2200₂ may be pre-stored in the user record. In other aspects, the transmission may be to the same user equipment (e.g., first user equipment 1 2200₁). The landscape images are displayed on the second user equipment 2 2200₂ for selection. The user selects one of the displayed landscape images 2208.

In response to the selection, the selected landscape image (or an indication of the selected landscape image) is transmitted to the authentication server 2105 (2210). Any transmitted landscape image(s) may be encrypted.

The authentication server 2105 compares 2212 the selected landscape image with the personal landscape image. When the selected landscape image is correct, e.g., same as the personal landscape image, the access is granted (2213) otherwise access is denied (2214). The authentication server 2105 may transmit the grant/denial to the first user equipment 2200₁ (2213/2214). In other aspect, when the selection is incorrect, the authentication server 2105 may allow a new selection. However, the authentication server 2105 may newly generate another set of random landscape images 2204. Additionally, the authentication server 2105 may also provide a notification to the first user equipment.

As used herein terms such as “a”, “an” and “the” are not intended to refer to only a singular entity but include the general class of which a specific example may be used for illustration. As used herein, terms defined in the singular are intended to include those terms defined in the plural and vice versa.

References in the specification to “one aspect”, “certain aspects”, “some aspects” or “an aspect”, indicate that the aspect(s) described may include a particular feature or characteristic, but every aspect may not necessarily include the particular feature, structure, or characteristic. Moreover, such phrases are not necessarily referring to the same aspect.

Aspects of the present disclosure may be implemented and run on a general-purpose computer or special-purpose computer system. The computer system may be any type known or will be known systems and may include a hardware processor, memory device, a storage device, input/output devices, internal buses, and/or a communications interface for communicating with other computer systems in conjunction with communication hardware and software, etc.

Various aspects of the present disclosure may be embodied as a program, software, or computer instructions embodied or stored in a computer or machine-usable or readable medium, or a group of media which causes the computer or machine to perform the steps of the method when executed on the computer, processor, and/or machine. A program storage device readable by a machine, e.g., a computer-readable medium, tangibly embodying a program of instructions executable by the machine to perform various functionalities and methods described in the present disclosure is also provided, e.g., a computer program product.

The computer-readable medium could be a computer-readable storage device or a computer-readable signal medium. A computer-readable storage device may be, for example, a magnetic, optical, electronic, electromagnetic, infrared, or semiconductor system, apparatus, or device, or any suitable combination of the foregoing; however, the computer-readable storage device is not limited to these examples except a computer-readable storage device excludes computer-readable signal medium. Additional examples of the computer-readable storage device can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an optical storage device, or any appropriate combination of the foregoing; however, the computer-readable storage device is also not limited to these examples. Any tangible medium that can contain, or store, a program for use by or in connection with an instruction execution system, apparatus, or device could be a computer-readable storage device.

A computer-readable signal medium may include a propagated data signal with computer-readable program code embodied therein, such as, but not limited to, in baseband or as part of a carrier wave. A propagated signal may take any of a plurality of forms, including, but not limited to, electro-magnetic, optical, or any suitable combination thereof. A computer-readable signal medium may be any computer-readable medium (exclusive of computer-readable storage device) that can communicate, propagate, or transport a program for use by or in connection with a system, apparatus, or device. Program code embodied on a computer-readable signal medium may be transmitted using any appropriate medium, including but not limited to wireless, wired, optical fiber cable, RF, etc., or any suitable combination of the foregoing.

The terms “computer system” and “network” as may be used in the present application may include a variety of combinations of fixed and/or portable computer hardware, software, peripherals, mobile, and storage devices. The computer system may include a plurality of individual components that are networked or otherwise linked to perform collaboratively, or may include one or more stand-alone components. The hardware and software components of the computer system of the present application may include and may be included within fixed and portable devices such as mobile phone, tablet, smartphone, desktop, laptop, and/or server. A module may be a component of a device, software, program, or system that implements some “functionality”, which can be embodied as software, hardware, firmware, electronic circuitry, or etc.

As used herein, the term “processor” may include a single core processor, a multi-core processor, multiple processors located in a single device, or multiple processors in wired or wireless communication with each other and distributed over a network of devices, the Internet, or the cloud. Accordingly, as used herein, functions, features or instructions performed or configured to be performed by a “processor”, may include the performance of the functions, features or instructions by a single core processor, may include performance of the functions, features or instructions collectively or collaboratively by multiple cores of a multi-core processor, or may include performance of the functions, features or instructions collectively or collaboratively by multiple processors, where each processor or core is not required to perform every function, feature or instruction individually. For example, multiple processors may allow load balancing. As used herein, the term “processor” may be replaced with the term “circuit”. The term “processor” may refer to, be part of, or include processor hardware (shared, dedicated, or group) that executes code and memory hardware (shared, dedicated, or group) that stores code executed by the processor.

In the description and claims herein, the term “about” indicates that the value listed may be somewhat altered, as long as the alteration does not result in nonconformance of the process or device. For example, for some elements the term “about” can refer to a variation of ±0.1%, for other elements, the term “about” can refer to a variation of ±1% or ±10%, or any point therein. For example, the term about when used for a measurement in mm, may include +/0.1, 0.2, 0.3, etc., where the difference between the stated number may be larger when the state number is larger. For example, about 1.5 may include 1.2-1.8, where about 20, may include 19.0-21.0.

Reference herein to any numerical range expressly includes each numerical value (including fractional numbers and whole numbers) encompassed by that range. To illustrate, reference herein to a range of “at least 50” or “at least about 50” includes whole numbers of 50, 51, 52, 53, 54, 55, 56, 57, 58, 59, 60, etc., and fractional numbers 50.1, 50.2 50.3, 50.4, 50.5, 50.6, 50.7, 50.8, 50.9, etc. In a further illustration, reference herein to a range of “less than 50” or “less than about 50” includes whole numbers 49, 48, 47, 46, 45, 44, 43, 42, 41, 40, etc., and fractional numbers 49.9, 49.8, 49.7, 49.6, 49.5, 49.4, 49.3, 49.2, 49.1, 49.0, etc.

The terminology used herein is for the purpose of describing particular aspects only and is not intended to be limiting the scope of the disclosure and is not intended to be exhaustive. Many modifications and variations will be apparent to those of ordinary skill in the art without departing from the scope and spirit of the disclosure.

What is claimed is:

1. A non-transitory computer-readable medium storing computer-readable instructions, the computer-readable instructions, when executed by a processor, cause the processor to perform operations comprising:
receiving a facial image of a person;
encoding the facial image into a latent vector using a first pre-trained machine learning model;
shuffling the latent vector using an invertible transformation in a latent space to generate a shuffled latent vector; and
converting the shuffled latent vector into a landscape image using a second pre-trained machine learning model,
wherein the landscape image is used for security screening.

2. The non-transitory computer-readable medium of claim 1, wherein the first pre-trained machine learning model and the second pre-trained machine learning are different machine learning techniques.

3. The non-transitory computer-readable medium of claim 1, wherein the first pre-trained machine learning model is an autoencoder deep learning network.

4. The non-transitory computer-readable medium of claim 1, wherein the second pre-trained machine learning model is a generative adversarial network (GAN).

5. The non-transitory computer-readable medium of claim 4, wherein the GAN comprises StyleGAN 2.

6. The non-transitory computer-readable medium of claim 1, wherein the shuffling comprises determining a block index number of the latent vector based on a defined indexed latent space, where the latent space is divided into blocks, determining a new block index number based on a bijective sequence of numbers, where the block index number of the latent vector defines a term number within the bijective sequence and moving the latent vector within the latent space based on the new block index number.

7. The non-transitory computer-readable medium of claim 6, wherein the moving is based on \tilde{v}=z_{R′(j}_{ᵥ}₎+v−zⱼ_{ᵥ},
where blocks are denoted by {Bⱼ}, where zⱼ denotes a vector that points to a center of a j-th block, jᵥ denotes the determined block index number of the latent vector, and R′(jᵥ) is the new block index number determined from the bijective sequence of numbers and v is the latent vector.

8. The non-transitory computer-readable medium of claim 1, wherein the shuffling comprises determining a Euclidean distance between the latent vector and a predefined center of the latent space and moving the latent vector based on the determined Euclidean distance, a rotation matrix and a scaling function.

9. The non-transitory computer-readable medium of claim 1, wherein the computer-readable instructions further cause the processor to perform:
encrypting the latent vector; and
transmitting the encrypted latent vector to an external screening station.

10. The non-transitory computer-readable medium of claim 1, wherein the computer-readable instructions further cause the processor to perform:
training a first machine learning model as the first pre-trained machine learning model;
defining shuffling parameters for the invertible transformation based on the training; and
training a second machine learning model as the second pre-trained machine learning model.

11. A screening system comprising:
a camera system:
an initial screening sub-system; and
a confirmation sub-system, the camera system, the initial screening sub-system and the confirmation sub-system are communicatively coupled,
the camera system comprising:
a camera-side communication interface;
a camera-side memory configured to store a first pre-trained machine learning model, a second pre-trained machine learning model and at least one shuffling method and associated parameters;
a camera configured to capture a facial image of a person;
a camera-side processor configured to:
encode the facial image into a latent vector using the first pre-trained machine learning model;
shuffle the latent vector using one of the shuffling methods and its associated parameters stored in memory to invertibly transform the latent vector in a latent space, to generate a shuffled latent vector;
convert the shuffled latent vector into a landscape image using the second pre-trained machine learning model;
transmit the landscape image to the initial screening sub-system via the camera-side communication interface,
the initial screening sub-system comprising:
a screening-side communication interface;
a screening-side memory configured to store the received landscape image and a plurality of reference landscape images;
a screening-display;
a screening-side user interface; and
a screening-side processor configured to cause the received landscape image and at least a subset of the plurality of reference landscape images to be displayed on the screening-display for comparison;
receive a comparison result via the screening-side user interface; and
in response to the comparison result indicating a match, transmit the received landscape image to the confirmation sub-system.

12. The screening system of claim 11, wherein the camera-side processor is further configured to encrypt the latent vector and transmit the encrypted latent vector to the confirmation sub-system.

13. The screening system of claim 12, wherein the confirmation sub-system comprises:
a conformation-side communication interface;
a confirmation-side memory configured to store at least one of a plurality of reference facial images or a plurality of reference landscape images, the received landscape image, and the first pre-trained machine learning model;
a confirmation-side display;
a confirmation-side user interface; and
a confirmation-side processor configured to
receive the encrypted latent vector and decrypt the encrypted latent vector and store the decrypted latent vector in the confirmation-side memory;
convert the decrypted latent vector into a recreated facial image using the first pre-trained machine learning model to recreate a facial image as the recreated facial image;
display the recreated facial image and display at least a subset of the plurality of reference facial images;
receive a result of comparison; and
cause an alert to be generated at least based on the comparison.

14. The system of claim 11, wherein the camera-side processor downloads the first pre-trained machine learning model, the second pre-trained machine learning model and the at least one shuffling method and associated parameters from a server.

15. The system of claim 14, wherein the server trains the first pre-trained machine learning model based on training facial images downloaded from an image repository and trains the second pre-trained machine learning model.

16. The system of claim 15, wherein at least a subset of the associated parameters for each shuffling method is based on respective latent vectors determined from the training facial images used to train the first pre-trained machine learning model.

17. The system of claim 14, wherein the initial screening sub-system downloads the plurality of reference landscape images from an external database and the confirmation sub-system downloads the at least one of a plurality of reference facial images or a plurality of reference landscape images from the external database.

18. The system of claim 17, wherein the initial screening sub-system downloads additional reference landscape images after initially downloading the plurality of reference landscape images.

19. The system of claim 11, wherein the first pre-trained machine learning model and the second pre-trained machine learning model are retrained in response to a training condition being satisfied.

20. An apparatus comprising:
a communication interface:
a memory configured to store a first pre-trained machine learning model, a second pre-trained machine learning model, at least one shuffling method and associated parameters and one or more reference landscape images;
a processor configured to:
receive a facial image via the communication interface;
encode the facial image into a latent vector using the first pre-trained machine learning model;
shuffle the latent vector using one of the shuffling methods and its associated parameters stored in memory to invertibly transform the latent vector in the latent space, to generate a shuffled latent vector;
convert the shuffled latent vector into a landscape image using the second pre-trained machine learning model;
display the landscape image along with the one or more reference landscape images;
receive a comparison result via a user interface; and
cause a notification to be generated based on the comparison.

21. A server comprising:
a communication interface;
a memory;
a processor configured to
train a first machine learning model based on a plurality of facial images to encode facial images into latent vectors;
determine parameters associated with at least one shuffling method for transforming latent vectors which are encoded using the first machine learning model from facial images, respectively, for screening;
train a second machine learning model to convert latent vectors into landscape images, respectively,
transmit the trained first machine learning model, the second machine learning model and the parameters associated with at least one shuffling method to a screening apparatus.

22. A system for authenticating a user comprising:
a memory configured to store information for a plurality of registered users, the information for each of the plurality of registered users comprising a user identifier, a user password and a unique landscape image, each unique landscape image being generated from a facial image of a user, respectively, by using a first machine learning model and a second machine learning model, the first machine learning model encoding a facial image into a latent vector and the second machine learning model converting a shuffled latent vector into a unique landscape image, where the latent vector is shuffled using an invertible transformation in a latent space to generate the shuffled latent vector; and
a processor configured to
receive a request for access via a communication interface from first user equipment of a user, the request including at least a user identifier of the user requesting access and a user password of the user requesting access;
match the user identifier and the user password in the request with a user identifier and user password in the memory,
in response to a matching, transmit, to second user equipment of the user, a plurality of landscape images including (i) the unique landscape image of the registered user whom matched the user identifier and the user password and (ii) other landscape images different from the unique landscape image;
receive, from the second user equipment, a selection of one of the plurality of landscape images; and
in response to the selection being the unique landscape image, grant access.

23. The system of claim 22, wherein the first user equipment and the second user equipment are different.

24. The system of claim 22, wherein the other landscape images of the plurality of landscape images are randomly generated by the processor in response to the matching.

25. The system of claim 22, wherein a number of the plurality of landscape images is 4.

26. The system of claim 22, wherein in response to the selection being one of the other landscape images, the processor is configured to transmit, to the second user equipment, another plurality of landscape images including (i) the unique landscape image and (ii) other landscape images different from the other landscape images in the previously transmitted plurality of landscape images.

27. A system for authenticating a user comprising:
a memory configured to store information for a plurality of registered users, the information for each of the plurality of registered users comprising a user identifier and a unique landscape image, each unique landscape image being generated from a facial image of a user, respectively, by using a first machine learning model and a second machine learning model, the first machine learning model encoding a facial image into a latent vector and the second machine learning model converting a shuffled latent vector into a unique landscape image, where the latent vector is shuffled using an invertible transformation in a latent space to generate the shuffled latent vector; and
a processor configured to
receive a request for access via a communication interface from user equipment of a user, the request including at least a user identifier and a unique landscape image of the user;
match the user identifier in the request with a user identifier in the memory to obtain the information of the registered user;
upon obtaining the information of the registered user, match the unique landscape image of the user in the request with the unique landscape image of the registered user stored in the memory; and
in response to a matching of the unique landscape images, grant access.
